(19) United States
(12) Patent Application Publication
(10) Pub. No.: US 2011/0257025 A1
(43) Pub. Date: Oct. 20, 2011

(54) METHOD FOR TUMOR CLASSIFICATION

(76) Inventors: René Houtman, Culemborg (NL); Robby Ruijtenbeek, Utracht (NL); Pieter Jacob Boender, Nijmegen (NL); Marinus Gerardus Johannes Van Beuningen, Oss (NL); Maria Helena Hilhorst, Wageningen (NL); Richard De Wijn, Nijmegen (NL)

(21) Appl. No.: 12/736,467

(22) PCT Filed: Apr. 10, 2009
(86) PCT No.: PCT/EP2009/054357

§ 371 Date: Oct. 8, 2010

(30) Foreign Application Priority Data
Apr. 11, 2008 (EP) 08154417.3

(51) Int. Cl. C40B 30/04; C40B 40/10

(52) U.S. Cl. 506/9; 506/18

(57) ABSTRACT

The present invention relates to methods for identifying classification markers for tumors by monitoring the activity of protein kinases. By acquiring a phosphorylation profile of diseased and control tissue samples the method of the present invention provides classification procedures using phosphorylation patterns enabling the distinction between different types and/or sub-types of tumors. Specific classification markers for tumors can be identified enabling tumor classification, diagnosis, prognosis and/or prediction of the clinical outcome of a therapy.

### FIELD OF THE INVENTION

The present invention relates to a method for identifying classification markers for tumors using an array of substrates, in particular protein kinase substrates, immobilized on a porous matrix. More particularly, the method is useful for classification procedures using phosphorylation patterns to enable the distinction between different types and/or sub-types of tumors.

### BACKGROUND

Classification of cancer is crucial in order to determine an appropriate treatment and to determine the prognosis of the disease. Cancer develops progressively from an alteration in a cell's genetic structure due to mutations, to cells with uncontrolled growth patterns. Classification is made according to the site of origin, histology, and the extent of the disease. The classification based on histology, also called grading, involves examining tumor cells that have been obtained through biopsy under a microscope. The abnormality of the cells determines the grade of the cancer. Current methods of diagnosing and treating cancers are, for the most part, based on this type of classification. However, since tumors with similar histopathological appearance can follow significantly different clinical courses and show different responses to therapy, this type of cancer classification based primarily on non-molecular parameters such as clinical course, morphology and histopathological characteristics of the tumor is not always effective.

At this moment, advanced molecular techniques, such as microarray technology, enable researchers to partially overcome this limitation, by enabling tumor subclass identification through global gene expression analysis. This technique profiles the expression of many thousand genes in one single experiment of a tumor tissue sample. The generated data may contribute to a more precise tumor classification, identification or discovery of new tumor subgroups, and to the prediction of clinical parameters relevant to prognosis or therapy response. However, even if these approaches show promising results, classification of clinical samples remains a challenging task due to the complexity and high dimensionality of microarray gene expression data.

Due to the large amount of data obtained during a microarray experiment, the results are highly complex and advanced data analysis methods are required to discover and describe hidden patterns within such data. The high complexity of the data analysis therefore makes it prone to errors.

Furthermore, the general application of microarray methods to establish classification methods for tumors is hampered by the fact that these methods rely on changes at the level of gene expression and therefore in protein abundance and protein function to deduce their role in cellular processes. Microarray experiments studying gene expression therefore provide only an indirect estimate of dynamics in protein function. Indeed, several important forms of post-transcriptional regulation, including protein-protein and protein-small-molecule interactions, determine protein function and may or may not be directly reflected in gene expression signatures. To address this issue, various strategies have been developed wherein active site-directed (ASD) substrates are used to profile the functional state of enzyme families directly. By developing ASD substrates that capture fractions of the proteome based on shared functional properties, rather than mere abundance, portions of the biomolecular space can be interrogated that were inaccessible by other large-scale profiling methods. Several enzyme classes can be addressed by this method, including all major classes of proteases, kinases, phosphatases, glycosidases, and oxidoreductases. This approach has succeeded in identifying enzyme activities associated with a range of diseases, including cancer, malaria, and metabolic disorders.

In general, notwithstanding much progress, the complex system wherein ASD substrates are subject to the action(s) of specific enzymes still requires much molecular examination in characterizing still unknown or largely unknown properties of enzymes governing signalling pathways, which in turn control cell growth, disease progression and cellular differentiation.

Signal transduction is one of the most important areas of investigation in biological research, and involves many types of interactions. One of the major mechanisms frequently employed by cells to regulate their activity, and in particular to regulate signal transduction processes, involves changes in protein phosphorylation. As many as up to 1000 kinases and 500 phosphatases in the human genome are thought to be involved in phosphorylation processes. The targets of phosphorylation encompass a large group of signalling molecules, including enzymes.

It has already been established that protein kinases, both tyrosine, serine and threonine kinases, play an important role in signalling pathways that are known to play key roles in tumor development and progression. A deregulation of protein kinase activity has been observed in many malignant neoplasms. Unusual protein kinase activity has also been discovered in pediatric brain tumors. However only a limited number of the known protein kinases have been investigated so far. Therefore there is a need for new methods and systems for tumor classification and prognosis. The present invention therefore provides a method for monitoring the activity of enzymes, in particular protein kinases. By acquiring a phosphorylation profile of diseased and control tissue samples the method of the present invention is useful for classification and prognosis purposes. In particular in oncology, the present invention provides markers that can be used for classification purposes. Furthermore, the present invention provides a method capable of providing an overview of the entire activity of protein kinases.

### SUMMARY OF THE INVENTION

Research on the involvement of the various pathways is often based on measurements of the end product of phosphorylation, by applying for instance western-blotting/immunoblotting. As kinase activity itself can be highly influenced by only small changes in regulatory effects it is worthwhile and sometimes essential to explore the actual enzymatic activity instead of the end point effects. This possibility is given by the dynamic incubation of cell lysates on the peptide arrays measuring the over all kinase activity at the moment of lysis.

The present invention therefore relates to a method wherein classification markers for tumors are identified. The method comprises the steps of:
a) determining kinase activity of one or more diseased tissue samples by incubating said diseased tissue sample with ATP on an array of two or more substrates, preferably protein kinase substrates, thereby generating a kinase activity profile;
b) determining kinase activity of one or more control tissue samples by incubating said control tissue sample with ATP on an array of two or more substrates, preferably protein kinase substrates, thereby generating a kinase activity profile
c) comparing the kinase activity profiles obtained in steps a) and b) for identifying classification markers.

The present invention further relates to a kinase activity profile obtained by the method of the present invention, said profile enabling tumor classification and/or diagnosis, prognosis and/or prediction of the clinical outcome of a therapy.

The present invention also relates to the use of a method according to the invention or a kinase activity profile according to the invention, for stratification, classification and/or sub-classification of diseases.

Furthermore, the present invention relates to an array of substrates comprising at least two protein kinase substrates selected from the group consisting of the protein kinase substrates with sequence numbers 1 to 157.

### DESCRIPTION OF THE FIGURES

FIG. 1 shows the distribution of a difference statistic differentiating between Astrocytomas and Glioblastomas.

FIG. 2 shows the distribution of a difference statistic differentiating between Astrocytomas and Ependymomas.

FIG. 3 shows kinase activity profiles of tumor cell lines obtained in the absence (A) and in the presence (B) of Gefitinib.

FIG. 4 shows a principal component analysis on data from normal colon and colon carcinoma samples.

FIG. 5 provides, as depicted in the examples, a graphical representation of the scores on the 4th principal component (PC) on the X-axis and that of the fifth PC on the Y axis, each point represents one of the 23 samples, filled circles represent ER negative samples and open circles represent ER positive samples.

FIG. 6 provides, as depicted in the examples, a graphical representation the sorting of breast tumor samples according to the ER status, wherein the Y-axis provides the prediction for each sample wherein ER negative samples are represented by a filled symbol, ER positive samples by an open symbol.

### DETAILED DESCRIPTION

Before the present method and devices used in the invention are described, it is to be understood that this invention is not limited to particular methods, components, or devices described, as such methods, components, and devices may, of course, vary. It is also to be understood that the terminology used herein is not intended to be limiting.

Unless defined otherwise, all technical and scientific terms used herein have the same meaning as commonly understood by one of ordinary skill in the art to which this invention belongs. Although any methods and materials similar or equivalent to those described herein may be used in the practice or testing of the present invention, the preferred methods and materials are now described.

In this specification and the appended claims, the singular forms “a”, “an”, and “the” include plural references unless the context clearly dictates otherwise.

The present invention bridges the gap between traditional tumor classification methods, and classification methods based on molecular biology assays by providing methods as described herein for assaying the activity of enzymes, in particular protein kinases, in respect of the classification of a tumor.

By ‘enzymes’ we refer to proteins that are able to modify substrates. The modified substrate might be either another enzyme or any other protein participating in the same signal transduction pathway. Also, peptides, nucleic acids, sugars etc may be modified by enzymes. Enzymes that may be analyzed include, but are not limited to, oxidoreductases including dehydrogenases, reductases and oxidases; transferases including methyltransferases, carbamoyltransferases, transketolases, acetyltransferases, phosphorylases, phosphoribosyltransferases, sialyltransferase; transaminases including kinases such as calcium/calmodulin kinase, cyclin-dependent kinases, lipid signaling kinases, mitogen-activated kinases, PDK1-PKB/Akt, PKA, PKC, PKG, non-receptor protein tyrosine kinases, receptor protein tyrosine kinases, serine/threonine kinases, protein phosphatases, hydrolases including lipases, esterases, hydrolases, phosphatases, phosphodiesterases, glucosidases, galactosidases, amidases, deaminases and pyrophosphatases; lyases including decarboxylases, aldolases, hydratases and ferrochelatases; isomerases including epimerases, isomerases, and mutases; ligases including GMP synthase, CTP synthase, NAD+ synthetase, and carboxylases. The methods according to the present invention are equally directed to enzymes without a known biologically active function.

Accordingly, in one embodiment of the present invention, methods are provided wherein the enzymatic activity is chosen from the group comprising kinase activity, protease activity, transferase activity, and proteinase activity. In a more preferred embodiment of the present invention, methods are provided wherein the enzymatic activity is kinase activity and more preferably protein kinase activity.

Protein kinase activity is referred to as the activity of protein kinases. A protein kinase is a kinase enzyme that modifies other proteins by chemically adding phosphate groups to them. This process or activity is also referred to as phosphorylation. Phosphorylation usually results in a functional change of the substrate by changing enzyme activity, cellular location, or association with other proteins. Up to 30% of all proteins may be modified by kinase activity, and kinases are known to regulate the majority of cellular pathways, especially those involved in signal transduction, the transmission of signals within the cell. The chemical activity of a kinase involves removing a phosphate group from ATP, or any other phosphate source, and covalently attaching it to amino acids such as serine, threonine, tyrosine, histidine aspartatic acid and/or glutamic acid that have a free hydroxyl group. Most known kinases act on both serine and threonine, others act on tyrosine, and a number act on all serine, threonine and tyrosine. The protein kinase activity monitored with the method of the present invention is preferably directed to protein kinases acting towards serine, threonine and/or tyrosine, preferably acting on both serine and threonine, on tyrosine or on serine, threonine and tyrosine.

Because protein kinases have profound effects on a cell, their activity is highly regulated. Kinases are turned on or off by for instance phosphorylation, by binding of activator proteins or inhibitor proteins, or small molecules, or by controlling their location in the cell relative to their substrates. Deregulated kinase activity is a frequent cause of disease, particularly cancer, where kinases regulate many aspects that control cell growth, movement and death. Therefore monitoring the protein kinase activity in tissues can be of great importance and a large amount of information can be obtained when comparing the kinase activity of different tissue samples.

Accordingly, within one embodiment of the present invention, a method is provided, wherein classification markers for tumors are identified. The method comprises the steps of:
a) determining kinase activity of one or more diseased tissue samples by incubating said diseased tissue sample with ATP on an array of two or more substrates, preferably protein kinase substrates, thereby generating a kinase activity profile;
b) determining kinase activity of one or more control tissue samples by incubating said control tissue sample with ATP on an array of two or more substrates, preferably protein kinase substrates, thereby generating a kinase activity profile; and,

c) comparing the kinase activity profiles obtained in steps a) and b) for identifying classification markers.

In another embodiment of the present invention, a method is provided, wherein classification markers for tumors are identified. The method comprises the steps of:
a) determining kinase activity of one or more diseased tissue samples by incubating said diseased tissue sample with ATP on an array of two or more substrates, preferably protein kinase substrates, thereby generating a kinase activity profile;
b) determining kinase activity of one or more control tissue samples by incubating said control tissue sample with ATP on an array of two or more substrates, preferably protein kinase substrates, thereby generating a kinase activity profile; and,
c) comparing the kinase activity profiles obtained in steps a) and b) thereby obtaining a differential kinase activity profile from which classification markers can be identified.

In a preferred embodiment of the present invention the differential kinase activity can be determined by comparing the kinase activity profiles obtained in steps a) and b) of the method of the present invention with other kinase activity profiles from other disease tissue samples. The kinase activity profiles from other disease tissue samples can for instance be kinase activity profiles obtained from earlier conducted tests.

In a preferred embodiment, three or more different tissue samples are compared is steps a) and b) in the method of the present invention. A comparison of three or more different tissue samples renders the method of the present invention more robust and more precise. When for instance the activity profile of a diseased tissue sample is compared to a large set of activity profiles from a database, the method of the present invention will be more specific and precise.

The substrates as used herein, are meant to include hormone receptors, peptides, proteins and/or enzymes. In particular the substrates used are kinase substrates, more in particular peptide kinase substrates, even more particular the peptide kinase substrates in Table 1 and/or Table 5, most particularly using at least 2, 3, 4, 5, 9, 10, 12, 16, 20, 30, 40, 50, 60, 70, 80, 90, 100, 110, 120, 130, 140, 144, 150, 157, 160, 170, 180, 190, 200 or 210 peptides of the peptide kinase substrates in Table 1 and/or Table 5. In a preferred embodiment the array of substrates comprises at least two peptides selected from the group consisting of the peptides with any of Seq.Id.No. 5, 8, 16, 17, 28, 37, 38, 40, 43, 44, 50, 57, 59, 61, 64, 76, 77, 78, 101, 103, 148, 153 and 156. In a more preferred embodiment the array of substrates comprises or consists of the peptides with any of Seq.Id.No. 5, 8, 16, 17, 28, 37, 38, 40, 43, 44, 50, 57, 59, 61, 64, 76, 77, 78, 101, 103, 148, 153 and 156.

In an alternative embodiment the array of substrates comprises at least two peptides selected from the group consisting of the peptides with any of Seq.Id.No. 17, 28, 40, 43, 44, 93, 100, 103, 121 and 126. In a more preferred embodiment the array of substrates comprises or consists of the peptides with any of Seq.Id.No. 17, 28, 40, 43, 44, 93, 100, 103, 121 and 126.

It should be noted that a person skilled in the art will appreciate that the kinase substrates used in the methods of the present invention and immobilized on the arrays of the invention may be the peptides as listed in Table 1 and/or Table 5. These peptides can be used according to the methods or arrays of the present invention to measure the phosphorylation levels of phosphorylation sites of said peptides in the presence of protein kinase present in the samples. The phosphorylation levels of the individual phosphorylation sites present in said peptides may be measured and compared in different ways. Therefore the present invention is not limited to the use of peptides identical to any of the peptides as listed in Table 1 and/or Table 5 as such. The skilled person may easily on the basis of the sequence of the peptides listed in Table 1 and/or Table 5 design variants compared to the specific peptides in said tables and use such variants in a method for measuring phosphorylation levels of phosphorylation sites present in said peptides as listed in Table 1 and/or Table 5. These variants may be peptides which have a one or more (2, 3, 4, 5, 6, 7, etc.) amino acids more or less than the given peptides and may also have amino acid substitutions (preferably conservative amino acid substitutions) as long as these variant peptides retain at least one or more of the phosphorylation sites of said original peptides as listed in said tables. Further the skilled person may also easily carry out the methods or construct arrays according to the present invention by using proteins (full length or N- or C-terminally truncated) comprising the amino acid regions of the peptides listed in Table 1 and/or Table 5 as sources for studying the phosphorylation of sites present in the amino acid regions of the peptides listed in Table 1 and/or Table 5. Also the skilled person may use peptide mimetics which mimic the peptides listed in Table 1 and/or Table 5. The present invention also includes the use of analogs and combinations of these peptides for use in the method or arrays according to the present invention. The peptide analogs include peptides which show a sequence identity of more than 70%, preferably more than 80% and more preferably more than 90%.

As used herein “peptide” refers to a short truncated protein generally consisting of 2 to 100, preferably 2 to 30, more preferably 5 to 30 and even more preferably 13 to 18 naturally occurring or synthetic amino acids which can also be further modified including covalently linking the peptide bonds of the alpha carboxyl group of a first amino acid and the alpha amino group of a second amino acid by eliminating a molecule of water. The amino acids can be either those naturally occurring amino acids or chemically synthesized variants of such amino acids or modified forms of these amino acids which can be altered from their basic chemical structure by addition of other chemical groups which can be found to be covalently attached to them in naturally occurring compounds.

As used herein “protein” refers to a polypeptide made of amino acids arranged in a linear chain and joined together by peptide bonds between the carboxyl and amino groups of adjacent amino acid residues.

As used herein “peptide mimetics” refers to organic compounds which are structurally similar to peptides and similar to the peptide sequences list in Table 1 and/or Table 5. The peptide mimetics are typically designed from existing peptides to alter the molecules characteristics. Improved characteristics can involve, for example improved stability such as resistance to enzymatic degradation, or enhanced biological activity, improved affinity by restricted preferred conformations and ease of synthesis. Structural modifications in the peptidomimetic in comparison to a peptide, can involve backbone modifications as well as side chain modification.

TABEL 1
list of 157 peptides used for determining
the kinase activity,their sequence and Seq.Id.No.

| Seq. | | |
|---|---|---|
| Id.No | Name | Sequence |
| 1 | 41_348_660_Y354 | LDGENIYIRHSNL |
| 2 | 41_653_665_Y627 | RLDGENIYIRHSN |
| 3 | ACHB_383_395_Y390 | WGRGTDEYFIRKP |
| 4 | ACHD_383_395_Y390 | YISKAEEYFLLKS |
| 5 | AMPE_5_17_Y12 | EREGSKRYCIQTK |
| 6 | ANXA1_13_25_Y20/T23 | IENEEQEYVQTVK |
| 7 | ANXA2_16_28_T18/S17/S21/S25/ | HSTPPSAYGSVKA |
| | Y23 | |
| 8 | ART_004_EAIYAAPFAKKKXC | EAIYAAPFAKKK |
| 9 | B3AT_39_51_Y46/S50 | TEATATDYHTTSH |
| 10 | C1R_199_211_S206 | TEASGYISSLEYP |
| 11 | CALM_93_105_Y99/S101 | FDKDGNGYISAAE |
| 12 | CALM_95_107_Y99/S101 | KDGNGYISAAELR |
| 13 | CBL_693_705_Y700 | EGEEDTEYMTPSS |
| 14 | CD3Z_116_128_Y123 | KDKMAEAYSEIGM |
| 15 | CD3Z_146_158_Y153 | STATKDTYDALHM |
| 16 | CD79A_181_193_Y182/Y188 | EYEDENLYEGLNL |
| 17 | CDK2_8_20_T14/Y15 | EKIGEGTYGVVYK |
| 18 | CDK7_157_169_S164 | GLAKSFGSPNRAY |
| 19 | CREB1_122_134_Y134/S133 | QKRREILSRRPSY |
| 20 | CRK_214_226_Y221 | GPPEPGPYAQPSV |
| 21 | CTNB1_79_91_Y86 | VADIDGQYAMTRA |
| 22 | DCX_109_121_Y112/S116 | GIVYAVSSDRFRS |
| 23 | DDR1_506_518_Y513 | LLLSNPAYRLLLA |
| 24 | DDR1_785_797_Y792/Y796/Y797 | FGMSRNLYAGDYY |
| 25 | DDR2_733_745_Y740 | RNLYSGDYYRIQG |
| 26 | DYR1A_212_224_Y219 | KHDTEMKYYIVHL |
| 27 | DYR1A_312_324_Y319/Y321 | CQLGQRIYQYIQS |
| 28 | EFS_246_258_Y253 | GGTDEGIYDVPLL |
| 29 | EFS_246_258_Y253F | GGTDEGIFDVPLL |
| 30 | EGFR_1062_1074_Y1069 | EDSFLQRYSSDPT |
| 31 | EGFR_1103_1115_Y1110 | GSVQNPVYHNQPL |
| 32 | EGFR_1118_1130_Y1125 | APSRDPHYQDPHS |
| 33 | EGFR_1165_1177_Y1172 | ISLDNPDYQQDFF |
| 34 | EGFR_1190_1202_Y1197 | STAENAEYLRVAP |
| 35 | EGFR_862_874_Y869 | LGAEEKEYHAEGG |
| 36 | EGFR_908_920_Y915 | MTFGSKPYDGIPA |
| 37 | ENOG_37_49_Y43 | SGASTGIYEALEL |
| 38 | EPHA1_774_786_Y781 | LDDFDGTYETQGG |
| 39 | EPHA2_581_593_Y588 | QLKPLKTYVDPHT |
| 40 | EPHA2_765_777_Y772 | EDDPEATYTTSGG |
| 41 | EPHA4_589_601_Y596 | LNQGVRTYVDPFT |
| 42 | EPHA4_921_933_Y928 | QAIKMDRYKDNFT |
| 43 | EPHA7_607_619_Y608/Y614 | TYIDPETYEDPNR |
| 44 | EPHB1_771_783_Y778 | DDTSDPTYTSSLG |
| 45 | EPHB1_921_933_Y928 | SAIKMVQYRDSFL |
| 46 | EPHB4_583_595_Y590 | IGHGTKVYIDPFT |
| 47 | EPOR_361_373_Y368 | SEHAQDTYLVLDK |
| 48 | EPOR_419_431_Y426 | ASAASFEYTILDP |
| 49 | ERBB2_1241_1253_Y1248 | PTAENPEYLGLDV |
| 50 | ERBB2_870_882_Y877 | LDIDETEYHADGG |
| 51 | ERBB2_945_957_Y952 | PISTIDVYMIMVK |
| 52 | ERBB4_1181_1193_Y1188 | QALDNPEYHNASN |
| 53 | ERBB4_1277_1289_Y1284 | IVAENPEYLSEFS |
| 54 | F261_26_38_S33 | RLQRRRGSSIPQF |
| 55 | FABH_13_25_Y19 | DSKNFDDYMKSLG |
| 56 | FAK1_569_581_Y576/Y577 | RYMEDSTYYKASK |
| 57 | FAK2_572_584_Y579/Y580 | RYIEDEDYYKASV |
| 58 | FER_707_719_Y714 | RQEDGGVYSSSGL |
| 59 | FES_706_718_Y713 | REEADGVYAASGG |
| 60 | FGFR1_759_771_Y766 | ALTSNQEYLDLSM |
| 61 | FGFR2_762_774_Y769 | TLTTNEEYLDLSQ |
| 62 | FGFR3_641_653_Y648 | DVHNLDYYKKTTN |
| 63 | FGFR3_753_765_Y760 | TVTSTDEYLDLSA |
| 64 | FRK_380_392_Y387 | KVDNEDIYESRHE |
| 65 | GSK3B_209_221_Y216 | RGEPNVSYICSRY |
| 66 | H2BR_26_38_S32/S36 | DGKKRKRSRKESY |
| 67 | INSR_1348_1360_S1354/Y1355 | SLGFKRSYEEHIP |
| 68 | INSR_993_1005_Y993/Y999 | YASSNPEYLSASD |
| 69 | IRS1_1222_1234_Y1230 | SSEDLSAYASISF |
| 70 | IRS2_535_545_Y540 | GGGGGEFYGYMTM |
| 71 | JAK1_1015_1027_Y1022/Y1023 | AIETDKEYYTVKD |
| 72 | K2C6E_53_65_S59 | GAGFGSRSLYGLG |
| 73 | K2C8_425_437_S431 | SAYGGLTSPGLSY |
| 74 | KSYK_518_530_Y525/Y526 | ALRADENYYKAQT |
| 75 | LAT_194_206_Y200 | MESIDDYVNVPES |
| 76 | LAT_249_261_Y255 | EEGAPDYENLQEL |
| 77 | LCK_387_399_Y394 | RLIEDNEYTAREG |
| 78 | LTK_669_681_Y772/Y776/Y777 | RDIYRASYYRRGD |
| 79 | MBP_198_210_Y203 | ARTAHYGSLPQKS |
| 80 | MBP_259_271_Y261/Y268/S266 | FGYGGRASDYKSA |
| 81 | MBP_263_275_Y268/S266/S270 | GRASDYKSAHKGF |
| 82 | MET_1227_1239_Y1230/Y1234/Y1235 | RDMYDKEYYSVHN |
| 83 | MK01_180_192_Y187 | HTGFLTEYVATRW |
| 84 | MK01_198_210_Y205 | IMLNSKGYTKSID |
| 85 | MK07_211_223_T218/Y220 | AEHQYFMTEYVAT |
| 86 | MK10_216_228_T221/Y223 | TSFMMTPYVVTRY |
| 87 | MK12_178_190_T183/Y185 | ADSEMTGYVVTRW |
| 88 | MK14_173_185_T180/Y182 | RHTDDEMTGYVAT |
| 89 | NCF1_313_325_S315/S320 | QRSRKRLSQDAYR |
| 90 | NPT2_501_513_T508 | AKALGKRTAKYRW |
| 91 | NTRK1_489_501_Y496 | HIIENPQYFSDAC |
| 92 | NTRK2_509_521_Y516 | PVIENPQYFGITN |
| 93 | NTRK2_695_707_Y702/Y706/Y707 | FGMSRDVYSTDYY |
| 94 | NTRK2_699_711_Y702/Y706/Y707 | RDVYSTDYYRVGG |
| 95 | ODBA_340_352_S345 | DDSSAYRSVDEVN |
| 96 | ODPAT_291_303_S291/S293 | SMSDPGVSYRTRE |
| 97 | P2AB_297_309_T304/Y307 | EPHVTRRTPDYFL |
| 98 | P85A_600_612_Y607/S608 | NENTEDQYSLVED |
| 99 | PAXI_111_123_Y118 | VGEEEHVYSFPNK |
| 100 | PAXI_24_36_Y31 | FLSEETPYSYPTG |
| 101 | PDPK1_2_14_Y9 | ARTTSQLYDAVPI |
| 102 | PDPK1_369_381_Y373/Y376 | DEDCYGNYDNLLS |
| 103 | PECA1_706_718_Y713 | KKDTETVYSEVRK |
| 104 | PERI_459_471_Y471 | QRSELDKSSAHSY |
| 105 | PGFRB_1002_1014_Y1009 | LDTSSVLYTAVQP |
| 106 | PGFRB_572_584_Y579/Y581 | VSSDGHEYIYVDP |
| 107 | PGFRB_709_721_Y716 | RPPSAELYSNALP |
| 108 | PGFRB_768_780_Y771/Y775/Y778 | SSNYMAPYDNYVP |
| 109 | PGFRB_771_783_Y771/Y775/Y778 | YMAPYDNYVPSAP |
| 110 | PLCG1_1246_1258_S1248/Y1253 | EGSFESRYQQPFE |
| 111 | PLCG1_764_776_Y771 | IGTAEPDYGALYE |
| 112 | PLCG1_776_788_Y783 | EGRNPGFYVEANP |
| 113 | PRGR_545_557_S552 | LRPDSEASQSPQY |
| 114 | PRGR_786_798_S793 | EQRMKESSFYSLC |
| 115 | PRRX2_202_214_Y214 | WTASSPYSTVPPY |
| 116 | PTN11_535_547_Y542 | SKRKGHEYTNIKY |
| 117 | RAF1_331_343_S337/S338/Y339/ | RPRGQRDSSYYWE |
| | Y340 | |
| 118 | RASA1_453_465_Y460 | TVDGKEIYNTIRR |
| 119 | RB_804_816_S807/S811 | IYISPLKSPYKIS |
| 120 | RBL2_99_111_Y111/S103 | VPTVSKGTVEGNY |
| 121 | RET_1022_1034_Y1029 | TPSDSLIYDDGLS |
| 122 | RET_680_692_Y687 | AQAFPVSYSSSGA |
| 123 | RON_1346_1358_Y1353 | SALLGDHYVQLPA |
| 124 | RON_1353_1365_Y1356/Y1360 | YVQLPATYMNLGP |
| 125 | SRC8_CHICK_470_482_Y477 | VSQREAEYEPETV |
| 126 | SRC8_CHICK_476_488_Y477/Y483 | EYEPETVYEVAGA |
| 127 | SRC8_CHICK_492_504_Y499 | YQAEENTYDEYEN |
| 128 | STA5A_687_699_Y694 | LAKAVDGYVKPQI |
| 129 | STAT1_694_706_Y701 | DGPKGTGYIKTEL |
| 130 | STAT2_683_695_Y690 | NLQERRKYLKHRL |
| 131 | STAT3_698_710_Y705 | DPGSAAPYLKTKF |
| 132 | STAT4_686_698_Y693 | TERGDKGYVPSVF |
| 133 | STAT4_714_726_Y725 | PSDLLPMSPSVYA |
| 134 | STAT6_634_646_Y641 | MGKDGRGYVPATI |
| 135 | SYN1_2_14_S9 | NYLRRRLSDSNFM |
| 136 | TAU_512_524_Y514/T522 | SGYSSPGSPGTPG |
| 137 | TEC_512_524_Y519 | RYFLDDQYTSSSG |
| 138 | TNNT1_2_14_Y9 | SDTEEQEYEEEQP |
| 139 | TYRO3_679_691_Y686 | KIYSGDYYRQGCA |
| 140 | VEGFR1_1040_1052_Y1048 | DFGLARDIYKNPD |
| 141 | VEGFR1_1046_1058_Y1053/Y148F | DIFKNPDYVRKGD |
| 142 | VEGFR1_1049_1061_Y1053 | KNPDYVRKGDTRL |
| 143 | VEGFR1_1162_1174_Y1169 | VQQDGKDYIPINA |
| 144 | VEGFR1_1206_1218_Y1213 | GSSDDVRYVNAFK |
| 145 | VEGFR1_1235_1247_Y1242 | ATSMFDDYQGDSS |
| 146 | VEGFR1_1320_1332_Y1327/C1320S/ | SSSPPPDYNSVVL |
| | C1321S | |
| 147 | VEGFR1_1326_1338_Y1333 | DYNSVVLYSTPPI |
| 148 | VEGFR2_1046_1058_Y1054 | DFGLARDIYKDPD |
| 149 | VEGFR2_1052_1064_Y1059 | DIYKDPDYVRKGD |
| 150 | VEGFR2_1068_1080_Y1175 | AQQDGKDYIVLPI |
| 151 | VEGFR2_1207_1219_Y1214/ | VSDPKFHYDNTAG |
| | C1208S | |
| 152 | VEGFR2_944_956_Y951 | RFRQGKDYVGAIP |
| 153 | VEGFR2_989_1001_Y996 | EEAPEDLYKDFLT |
| 154 | VGFR3_1061_1073_Y1063/Y1068/ | DIYKDPDYVRKGS |
| | S1073 | |
| 155 | VINC_815_827_Y821 | KSFLDSGYRILGA |
| 156 | ZAP70_485_497_Y492/Y493 | ALGADDSYYTARS |
| 157 | ZBT16_621_633_S628 | LRTHNGASPYQCT |

The term ‘tissue sample’ as used herein, refers to a sample obtained from an organism such as human or from components (e.g., cells) of such an organism. The sample could in principle be any biological sample, such as for example blood, urine, saliva, tissue biopsy or autopsy material and then in particular cell lysates thereof, but would typically consist of cell lysates prepared from cell lines, including cancer cell lines; primary and immortalized tissue cell lines; non-human animal model biopsies and patient biopsies. In one embodiment of the invention, the cell lysates are prepared from cancer cell lines; xenograft tumors or cancer patient biopsies, including tumor and normal tissue. Frequently a sample will be a ‘clinical sample’ which is a sample derived from a patient. Such samples include, but are not limited to, sputum, blood, blood fractions such as serum including fetal serum (e.g., SFC) and plasma, blood cells (e.g., white cells), tissue or fine needle biopsy samples, urine, peritoneal fluid, and pleural fluid, or cells there from.

The tissue samples may also refer to surrogate tissues. The ideal tissue to perform pharmacodynamic studies is the own tumor. However, taking in consideration the difficulties to perform sequential tumor biopsies, surrogate tissues can be used instead. Therefore, a distant tissue, such as skin tissue, can be used as a surrogate tissue for a cancerous tissue. The surrogate tissue can be used to monitor, or predict the effects of a drug. For example skin and hair tissue are known for their use as a prediction for the response of tumors to treatment with signalling inhibitors.

Since the present invention relates to a method for classifying cancer, it involves providing a tissue or fluid sample from the patient, the sample containing tumor cells.

In a preferred embodiment of the present invention the diseased tissue sample is a tumor tissue sample. The tumor tissue sample can be obtained from any cancer known in the art and for instance chosen from the group comprising brain cancer, breast cancer, prostate cancer, ovarian cancer, colon cancer, endometrium cancer, lung cancer, bladder cancer, stomach cancer, osteophagus cancer, oral tongue cancer, oral cavity cancer, skin cancer, mesotheliomas, retinoblastomas, and/or nephroblastomas and more preferably brain cancer, breast cancer, ovarian cancer and/or colon cancer.

In a preferred embodiment of the present invention the control tissue sample is a healthy tissue sample and/or a tissue sample similar to but different from the diseased tissue sample. Since the control tissue sample is used as a reference sample to compare with the diseased tissue sample, it can either be taken from a healthy tissue, a tissue similar to but different from the diseased tissue or the diseased tissue sample can be compared to two or more control tissue samples. It is preferably the intention of the method of the present invention to compare the kinase activity profile of the diseased tissue sample with that of one or more control tissue samples. Healthy tissue samples can be taken from the same individual and same organ but non-cancerous tissue, or from non-diseased individuals. With a tissue sample similar to but different from the diseased tissue sample is meant a tissue sample taken from a patient that is suffering from a sub-disease (e.g. sub-diseases of brain cancer are astrocytomas and ependymomas, or in case of head and neck cancer, sub-diseases are pharynx and larynx cancer). For example, when the diseased tissue sample is a brain tumor sample, the healthy tissue sample can for instance be a tissue sample taken from non-tumorous brain tissue. A tissue sample similar to but different from the brain tumor tissue sample can for instance be an ependymoma or glioblastoma brain tumor tissue sample, when the diseased tissue sample is an astrocytoma.

The control tissue can either be a non-diseased tissue sample, a different diseased tissue sample, a different sub-disease tissue sample and/or a tissue sample that has been treated or pretreated with a drug.

The tissue samples used in the preferred method of the present invention can be pretreated. The pretreatment of the tissue samples depends on the particular compound to be tested, and the type of sample used. The optimum method can be readily determined by those skilled in the art using conventional methods and in view of the information set out herein. Preferably, the tumor tissue samples are lysates. For example, the tissue sample is obtained by lysing the tumor tissue in a particular buffer comprising phosphatases and protease inhibitors.

The tissue samples show a particular enzymatic activity such as for instance a kinase activity due to the protein kinases present in the tissue. Therefore, contacting the tissue samples with an array of two or more substrates and preferably kinase substrates, and more in particular peptide kinase substrates, in the presence of ATP will lead to a phosphorylation of the kinase substrates. This response of the kinase substrates, also referred to as the kinase activity profile of that tissue, can be determined using a detectable signal. The signal is the result from the interaction of the sample with the array of substrates. The response of the array of substrates can be monitored using any method known in the art. The response of the array of substrates is determined using a detectable signal, said signal resulting from the interaction of the sample with the array of substrates. As mentioned hereinbefore, in determining the interaction of the sample with the array of substrates the signal is either the result of a change in a physical or chemical property of the detectably labeled substrates, or indirectly the result of the interaction of the substrates with a detectably labeled molecule capable of binding to the substrates. For the latter, the molecule that specifically binds to the substrates of interest (e.g., antibody or polynucleotide probe) can be detectably labeled by virtue of containing an atom (e.g., radionuclide), molecule (e.g., fluorescein), or complex that, due to a physical or chemical property, indicates the presence of the molecule. A molecule may also be detectably labeled when it is covalently bound to or otherwise associated with a “reporter” molecule (e.g., a biomolecule such as an enzyme) that acts on a substrate to produce a detectable atom, molecule or other complex.

Detectable labels suitable for use in the present invention include any composition detectable by spectroscopic, photochemical, biochemical, immunochemical, electrical, optical or chemical means. Labels useful in the present invention include biotin for staining with labeled avidin or streptavidin conjugate, magnetic beads (e.g., Dynabeads'), fluorescent dyes (e.g., fluorescein, fluorescein-isothiocyanate (FITC), Texas red, rhodamine, green fluorescent protein, enhanced green fluorescent protein and related proteins with other fluorescence emission wavelengths, lissamine, phycoerythrin, Cy2, Cy3, Cy3.5, Cy5, Cy5.5, Cy7, FluorX [Amersham], SYBR Green I & II [Molecular Probes], and the like), radiolabels (e.g., 3H, 125I, 35S, 4C, or 32P), enzymes (e.g., hydrolases, particularly phosphatases such as alkaline phosphatase, esterases and glycosidases, or oxidoreductases, particularly peroxidases such as horse radish peroxidase, and the like), substrates, cofactors, inhibitors, chemilluminescent groups, chromogenic agents, and colorimetric labels such as colloidal gold or colored glass or plastic (e.g., polystyrene, polypropylene, latex, etc.) beads.

Means of detecting such labels are well known to those of skill in the art. Thus, for example, chemiluminescent and radioactive labels may be detected using photographic film or scintillation counters, and fluorescent markers may be detected using a photodetector to detect emitted light (e.g., as in fluorescence-activated cell sorting). Enzymatic labels are typically detected by providing the enzyme with a substrate and detecting a colored reaction product produced by the action of the enzyme on the substrate. Colorimetric labels are detected by simply visualizing the colored label. Thus, for example, where the label is a radioactive label, means for detection include a scintillation counter, photographic film as in autoradiography, or storage phosphor imaging. Where the label is a fluorescent label, it may be detected by exciting the fluorochrome with the appropriate wavelength of light and detecting the resulting fluorescence. The fluorescence may be detected visually, by means of photographic film, by the use of electronic detectors such as charge coupled devices (CCDs) or photomultipliers and the like. Similarly, enzymatic labels may be detected by providing the appropriate substrates for the enzyme and detecting the resulting reaction product. Also, simple colorimetric labels may be detected by observing the color associated with the label. Fluorescence resonance energy transfer has been adapted to detect binding of unlabeled ligands, which may be useful on arrays.

In a particular embodiment of the present invention the response of the array of substrates to the sample is determined using detectably labeled antibodies; more in particular fluorescently labeled antibodies. In those embodiments of the invention where the substrates consist of kinase substrates, the response of the array of substrates is determined using fluorescently labeled anti-phosphotyrosine antibodies, fluorescently labeled anti-phosphoserine or fluorescently labeled anti-phosphoserine antibodies. The use of fluorescently labeled anti-phosphotyrosine antibodies or fluorescently labeled anti-phosphoserine or fluorescently labeled anti-phosphoserine antibodies in a flow-through array, such as a pamchip, allows real-time or semi real-time determination of the substrate activity and accordingly provides the possibility to express the array activity as the initial kinase velocity.

In a preferred embodiment of the present invention, the response of the array of kinase substrates is determined using fluorescently labeled anti-phosphotyrosine or fluorescently labeled anti-phosphoserine or fluorescently labeled anti-phosphoserine antibodies antibodies. Furthermore, the use of fluorescently labeled anti-phosphotyrosine antibodies or fluorescently labeled anti-phosphoserine or fluorescently labeled anti-phosphoserine antibodies in a flow-through array, such as a pamchip, do not prevent real-time or semi real-time determination of the substrate activity and accordingly provides the possibility to express the array activity as the initial kinase velocity

In a preferred embodiment of the present invention the method further comprises the presence of one or more protein kinase inhibitor in steps a) and b). In another embodiment the method further comprises the presence one or more protein phosphatases in steps a) and b).

By providing a protein kinase inhibitor in the steps where the kinase activity of the tissue samples is determined, it was surprisingly shown that the presence of the protein kinase inhibitor resulted in a better differentiation between kinase activity of the diseased tissue sample and the kinase activity of the control tissue sample. This surprising effect is due to the promiscuous characteristics of protein kinases. This results in a more efficient identification of the classification markers. This higher efficiency results, for example, in more peptides being statistically differentially phosphorylated when comparing inhibition profiles with activity profiles. The statistical analysis of differential phosphorylation can be done using multivariate and/or univariate statistical methods known in the art and for instance, but not limited to, using a student t-test. Inhibition profiles are obtained by (numerically) comparing the peptide phosphorylation profiles in the presence and in the absence of a drug in the same tissue sample, for instance, but not limited to, providing ratios or differences of the profiles obtained in the presence and the absence of the drug. The drug can be any kind of chemical substance for instance used in the treatment, cure, prevention, or diagnosis of disease or used to otherwise enhance physical or mental well-being.

In addition, because the inhibition profiles are generated by comparing the same tissue sample in the presence and the absence of the drug, preferably during a parallel series of measurements in the same instrument run, the inhibition profiles are surprisingly found to be less affected by variation, for example biological variation, experimental variation, compared to activity profiles. This allows the determination of better classification markers for example classification markers that are more robust or more sensitive.

In the present application “classification markers” refer to differences between the phosphorylation profiles of different tissue samples thereby providing grounds on which a person skilled in the art is able to differentiate between the different tissue samples. For instance in oncology, these classification markers can lead to an identification of a certain tumor thereby classifying this tumor in a certain class and/or sub-class.

Additionally, it should be noted that these classification markers can lead to an identification of a certain tumor known to have an increases chance of being responsive to a certain therapy. In this case these markers are also referred to as “response prediction markers”. Thus such subtype of classification markers refer to differences between the phosphorylation profiles of different tissue samples (treated or not treated with a drug) thereby providing grounds on which a person skilled in the art is able to differentiate between the different tissue samples being derived from patients responding or not-responding to a drug treatment, thereby enabling the prediction of a drug response based. A test based on such markers is used for prediction of the clinical outcome of a therapy.

The present invention therefore provides methods for the classification and subclassification, of tumors. Such classification (or subclassification) has many beneficial applications. For example, a particular tumor class or subclass may correlate with prognosis and/or susceptibility to a particular therapeutic regimen. As such, the classification or subclassification may be used as the basis for a prognostic or predictive kit and may also be used as the basis for identifying previously unappreciated therapies. Therapies that are effective against only a particular class or subclass of tumor may have been lost in studies whose data were not stratified by subclass; the present invention allows such data to be re-stratified, and allows additional studies to be performed, so that class- or subclass-specific therapies may be identified and/or implemented.

It is likely that for a person skilled in the art, in at least some instances, tumor class or subclass identity correlates with prognosis or responsiveness. In such circumstances, it is possible that the same set of interaction partners can act as both a classification panel and a prognosis or predictive panel.

The peptide sets described in the present application are promising candidates for peptides that are classification markers whose interaction partners are useful in tumor classification and subclassification according to the present invention.

An example of a classification in the prior art is the classification of breast cancer tissues on ‘poor prognosis’ or ‘good prognosis’.

The array of substrates is preferably a microarray of substrates wherein the substrates are immobilized onto a solid support or another carrier. The immobilization can be either the attachment or adherence of two or more substrate molecules to the surface of the carrier including attachment or adherence to the inner surface of said carrier in the case of e.g. a porous or flow-through solid support.

In a preferred embodiment of the present invention, the array of substrates is a flow-through array. The flow-through array as used herein could be made of any carrier material having oriented through-going channels as are generally known in the art, such as for example described in PCT patent publication WO 01/19517. Typically the carrier is made from a metal oxide, glass, silicon oxide or cellulose. In a particular embodiment the carrier material is made of a metal oxide selected from the group consisting of zinc oxide, zirconium oxide, tin oxide, aluminium oxide, titanium oxide and thallium; in a more particular embodiment the metal oxide consists of aluminium oxide.

In a preferred embodiment of the present invention, the substrates are at least 2, 3, 4, 5, 9, 10, 12, 16, 20, 30, 40, 50, 60, 70, 80, 90, 100, 110, 120, 130, 140, 144, 150, 157, 160, 170, 180, 190, 200 or 210 protein kinase substrates used in the methods or arrays of the present invention selected from the group consisting of the protein kinase substrates with any of Seq.Id.No. 1 to 157 and/or Seq.Id.No. 158 to 210, most particularly using at least two peptides selected from the group consisting of the peptides with any of Seq.Id.No. 5, 8, 16, 17, 28, 37, 38, 40, 43, 44, 50, 57, 59, 61, 64, 76, 77, 78, 101, 103, 148, 153 and 156. In a more preferred embodiment the substrates are the peptides with any of Seq.Id.No. 5, 8, 16, 17, 28, 37, 38, 40, 43, 44, 50, 57, 59, 61, 64, 76, 77, 78, 101, 103, 148, 153 and 156.

In an alternative embodiment the substrates are at least two protein kinase substrates selected from the group consisting of the peptides with any of Seq.Id.No. 17, 28, 40, 43, 44, 93, 100, 103, 121 and 126. In a more preferred embodiment the substrates are the peptides with any of Seq.Id.No. 17, 28, 40, 43, 44, 93, 100, 103, 121 and 126.

The present invention also relates to a kinase activity profile and/or a differential kinase activity profile obtained by the method of the present invention. The kinase activity profile and/or the differential kinase activity profile thereby enables the classification of the diseased tissue used in the present application. Examples of the classification are for instance, but not limited to, classification of non-diseased tissues from diseased tissues; classification of diseased tissues from tissues of a different disease such as brain cancer versus colon cancer; classification of diseased tissues from tissues of a similar but different disease; classification of sub-classes of a diseased tissue such as for brain cancer the differentiation between astrocytomas and ependymomas, or for leukemia the differentiation between chronic myeloid leukemia (CML), acute lymfoblastic leukemia (ALL) and acute myeloid leukemia (AML); classification of drug responsive tissue from drug non-responsive tissue, where the tissue is identical and/or obtained from the same tumor or patient; classification of tissues from different diseases or the classification of tissues from two or more different tumor origins.

The present invention also relates to a method for distinguishing between diseased and healthy tissue samples, the method comprising: providing a computer platform comprising reference kinase activity profiles and/or differential kinase activity profiles from healthy and diseased tissue samples and comparing the kinase activity profile and/or differential kinase activity profile of the tissue samples analysed using the method of the present invention with said reference profiles. The computer program can be provided on a data carrier comprising reference kinase activity profiles and/or differential kinase activity profiles. Said computer program would enable the classification of the diseased tissue. Furthermore, said computer program can be used for diagnostical purposes, prognostical purposes, for the prediction of the clinical outcome of a therapy, for treatment predictive purposes for stratification and/or for classification and/or sub-classification of diseases

Furthermore, the present invention relates to a kinase activity profile and/or a differential kinase activity profile obtained by the method of the present invention, wherein said kinase activity profile and/or said differential kinase activity profile is specific for a pathology. Potential pathologies include, but are not limited to oncological diseases, metabolic diseases, immunological and autoimmunological diseases, diseases of the nervous system and/or infectious diseases.

Furthermore, the present invention relates to a kinase activity profile and/or differential kinase activity profile obtained by the method of the present invention, wherein said kinase activity profile and/or differential kinase activity profile can be used for diagnostical and/or prognostical purposes and/or for the prediction of the clinical outcome of a therapy. For example the method of the present invention can be used to diagnose a cancer and preferably brain cancer, thereby differentiating between benign and malignant tumors.

In another embodiment, the present invention relates to a method according to the present invention, the use of a method according to the invention, an array according to the present invention or a kinase activity profile and/or a differential kinase activity profile according to the invention, for stratification, classification and/or sub-classification of diseases. For example the method of the present invention can be used to sub-classify astrocytoma or ependymoma within brain cancer or for example the differentiation between “poor prognosis” breast cancer from “good prognosis” breast cancer. Also the method can provide biomarkers for determining the estrogen receptor status of a breast tumor.

With stratification of individuals, types of cancer or cancer cells according to the invention is meant to divide said individuals or patients or types of cancer or types of cancer cells into sub-groups based on certain characteristics or phenotypes. Examples therefore include, but are not limited to, the stratification of tumor sub-types that are likely to go into metastasis against tumor sub-types that are not.

In another embodiment, the present invention relates to a method according to the present invention, the use of a method according to the invention, an array according to the present invention or a kinase activity profile and/or a differential kinase activity profile according to the invention, for diagnostical, prognostical, and/or treatment predictive purposes. The kinase activity profiles and/or differential kinase activity profiles can for instance be used to assess the likelihood of a particular favourable or unfavourable outcome, susceptibility (or lack thereof) to a particular therapeutic regimen, etc.

The present invention relates in another embodiment to an array of substrates for carrying out the method of the present invention comprising at least two protein kinase substrates selected from the group consisting of the protein kinase substrates with any of Seq.Id.No. 1 to 157 and/or Seq.Id.No. 158 to 214, most particularly using at least two peptides selected from the group consisting of the peptides with any of Seq.Id.No. 5, 8, 16, 17, 28, 37, 38, 40, 43, 44, 50, 57, 59, 61, 64, 76, 77, 78, 101, 103, 148, 153 and 156. In a more preferred embodiment the substrates are the peptides with any of Seq.Id.No. 5, 8, 16, 17, 28, 37, 38, 40, 43, 44, 50, 57, 59, 61, 64, 76, 77, 78, 101, 103, 148, 153 and 156.

In an alternative embodiment the substrates are at least two protein kinase substrates selected from the group consisting of the peptides with any of Seq.Id.No. 17, 28, 40, 43, 44, 93, 100, 103, 121 and 126. In a more preferred embodiment the substrates are the peptides with any of Seq.Id.No. 17, 28, 40, 43, 44, 93, 100, 103, 121 and 126.

In a particular embodiment, the method of the present invention further comprises the presence of a drug in steps a) and/or b). By providing a drug during the steps where the kinase activity is determined, the effect of that drug to a specific disease state of condition can be assessed. This method was found particular useful in the prediction of drug response, i.e. to enable the distinction between responders and non-responders in the treatment of cells, tissues, organs or warm-blooded animals with the compound to be tested, and in compound differentiation.

Therefore the method of the present invention also relates to a method or array according to the present invention or the use of the method of the present invention to assess the susceptibility of a biological species having a specific disease state or cellular condition to a drug.

the method of the present invention also relates to a method or array according to the present invention or the use of the method of the present invention for assessing the pharmaceutical value of a drug.

Furthermore, the method of the present invention can be used for assessing the pharmaceutical value of a drug and/or the clinical value of a drug. When assessing the pharmaceutical and/or clinical value of a drug, that drug is present during steps a) and/or b) of the method of the present invention.

In a further embodiment, the present invention provides a kit offering the necessary components for performing the method of the present invention.

### EXAMPLES

### Example 1

The method of the present invention has been optimized to allow classification of pediatric brain tumors. Tumor tissue was obtained from pediatric brain tumors including Astrocytomas, Ependymomas and glioblastomas. Cryptome cut slices with a thickness of about 10 μm, embedded in tumor tissue were lysed in 100 microliter Mammalian Extration Buffer (M-PER) containing phosphatase and protease inhibitors. Five microliter of the lysis solution was pipetted into a reaction mixture composed of 1×ABL buffer (New England Biolabs, B6050S), 0.1% Bovine Serum Albumin, 100 μM ATP, 20 μg/ml phosphotyrosine antibody to an end volume of 40 microliter. Before incubation a blocking step was carried out on the substrate arrays with 0.2% bovine serum albumin. After loading of the reaction mixtures into Pamchip arrays comprising 144 peptides (protein kinase substrates) each, incubation was commenced thereby measuring the kinase activity of each sample. Real time data were obtained by measuring fluorescence of the bound anti-phosphotyrosine antibody after each 5 cycles. Image quantification and data processing was conducted with dedicated Pamgene software (Evolve and Bionavigator). Subsequent data analysis was performed using Matlab (release 2007B, MathWorks Inc).

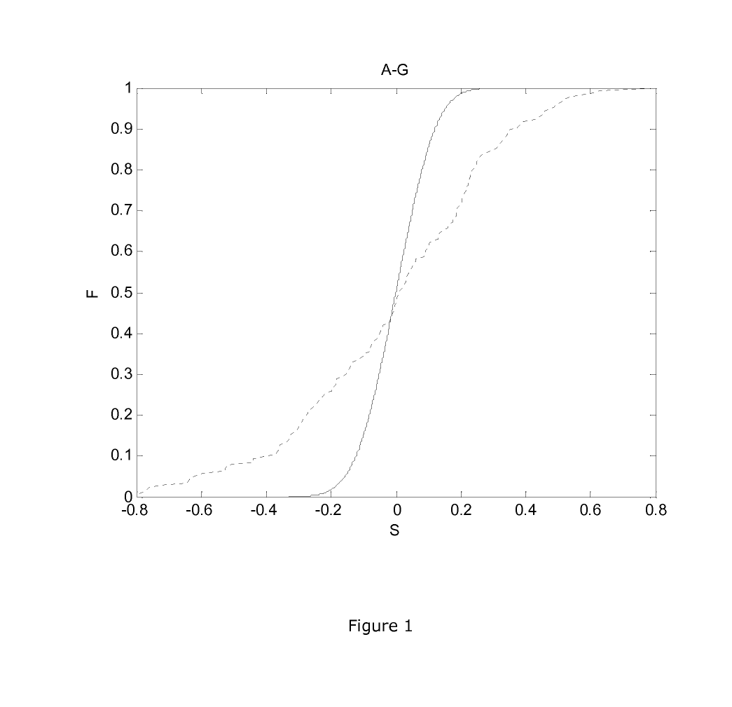

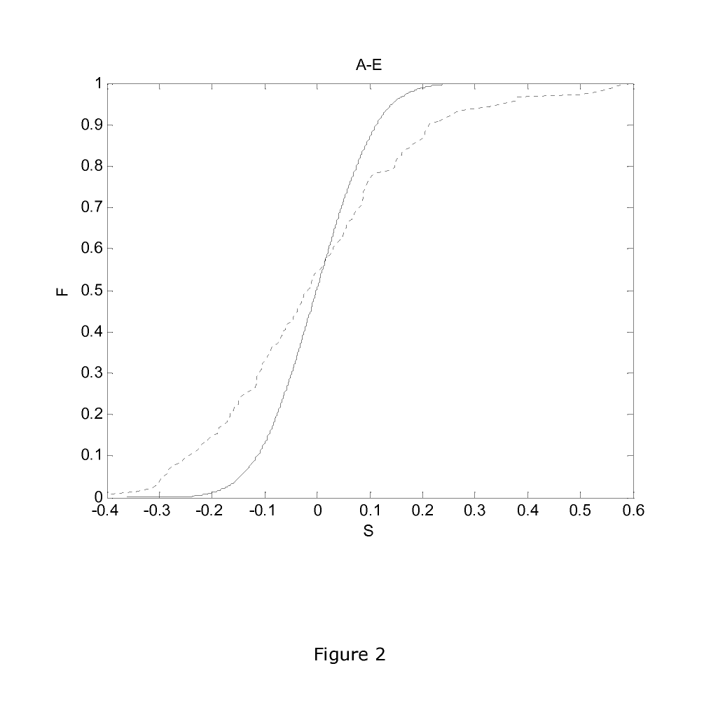

Data from arrays incubated with Astrocytomas (A) and Glioblastomas (G) respectively, were compared. Therefore, peptides were selected by calculating an A-G difference statistic S for each peptide (i.e. the “Signal-to noise” statistic from: A practical approach to microarray data analysis, Kluwer, 2003, chapter 9). FIG. 1 shows the cumulative distribution of experimentally obtained values of the S statistic (dotted line) compared to the values of the S statistic calculated with the A and G labels randomly permuted over the samples (random classification, repeated 100 times) shown as the full line. The more positive or negative a signal-to-noise value, the more difference is observed for the associated peptide between A and G data. The label “S” of the horizontal axis of the graph denotes “S statistic”, the labels “F” of the vertical axis of the graph denotes “Fraction of Peptides”. A similar graph comparing Astrocytomas (A) and Ependymomas (E) is shown in FIG. 2.

The results show that classification markers can be identified that discern astrocytomas from ependymomas, as well as glioblastomas from astrocytomas. Class prediction was performed using a linear Support Vector Machine (SVM) that performs pattern recognition to find conditions with a common function from the peptide phosphorylation data. For classifying A against G data only peptides with an absolute value of S larger than 0.25 were used and an error rate of 10% resulted from a leave-one-out cross validation. For classifying A against E data only peptides with an absolute value of S larger than 0.3 were used and an error rate of 20% resulted from a leave-one-out cross validation.

### Example 2

The method as described in example 1 was used to measure the phosphorylation activity of 31 clinical brain tumor tissue types. Kinase activity profiles were obtained from 8 piloid astrocytomas, 9 ependymomas, 12 medulloblastomas of which 3 supratentorial Primitive neuroectodermal tumors (PNETs), and 2 glioblastomas (tested in threefold). Each clinical sample was tested in 8 technical replicas. The average standard of 144 standard deviations of peptides with a signal above 100 arbitrary units was used to determine the technical variability within each of the 31 tested clinical samples. The sample with the highest coefficient of variance was removed from the data set. The raw phosphorylation activity data was loaded into GeneSpring GX 7.3 and normalized using a cross-gene error model. Each peptide phosphorylation was divided by the 80.0th percentile of all peptide phosphorylations in that sample. Each peptide phosphorylation was divided by the median of its measurements in all 35 clinical samples.

Supervised class prediction analysis was performed to predict the clinical type or “class”, of an individual clinical sample in two steps. First, all the peptide phosphorylation in the training set were individually examined and ranked on their power to discriminate each class from all the others. Next the most predictive 46 peptide phosphorylations (Table 3) were used to classify the “test set”. The class prediction to determine and cross validate the “test set” was based on support vector machines (SVMs), which uses pattern recognition to identify sets of conditions with a common function from the peptide phosphorylation data. A Kernel based on radial basis functions (Gaussian) was used. A Diagonal Scaling Factor of 1 was used given the unbalanced class sizes.

Crossvalidate the “test set” or also termed as a leave-one-out principle was used to predict the parameter values of the training set

Table 2 and table 3 show the results of the brain tumor type classification using the most predictive 46 peptides shown in table 4. Good classification results were obtained with the

TABLE 2

| | | Predicted | Score out of | |
|---|---|---|---|---|
| Sample ID | True type | type | seven | |
| T99-7086 | astrocytoma | astrocytoma | 71% | TRUE |
| T99-10089 | astrocytoma | astrocytoma | 86% | TRUE |
| T03-11282 | astrocytoma | glioblastoma | 14% | FALSE |
| T03-12665 | astrocytoma | astrocytoma | 86% | TRUE |
| T04-2111 | astrocytoma | astrocytoma | 100% | TRUE |
| T04-7727 | astrocytoma | astrocytoma | 86% | TRUE |
| T04-13463 | astrocytoma | astrocytoma | 86% | TRUE |
| T04-13474 | astrocytoma | astrocytoma | 100% | TRUE |
| T04-1519 | ependymoma | ependymoma | 57% | TRUE |
| T04-10331 | ependymoma | medulloblastoma | 29% | FALSE |
| T04-12881 | ependymoma | ependymoma | 100% | TRUE |
| T03-4264 | ependymoma | ependymoma | 57% | TRUE |
| T03-14184 | ependymoma | ependymoma | 57% | TRUE |
| T98-1776 | ependymoma | ependymoma | 71% | TRUE |
| T00-5259 | ependymoma | ependymoma | 100% | TRUE |
| T00-16111 | ependymoma | ependymoma | 71% | TRUE |
| T03-123715 | ependymoma | medulloblastoma | 29% | FALSE |
| T06-2969 | glioblastoma | glioblastoma | 100% | TRUE |
| T06-11567 | glioblastoma | glioblastoma | 86% | TRUE |
| T06-2969 | glioblastoma | glioblastoma | 71% | TRUE |
| T06-11567 | glioblastoma | astrocytoma | 29% | FALSE |
| T06-2969 | glioblastoma | glioblastoma | 100% | TRUE |
| T06-11567 | glioblastoma | glioblastoma | 71% | TRUE |
| T97-15875 | medulloblastoma | medulloblastoma | 71% | TRUE |
| T98-9106 | medulloblastoma | medulloblastoma | 57% | TRUE |
| T99--1288 | medulloblastoma | medulloblastoma | 86% | TRUE |
| T01-4335 | medulloblastoma | ependymoma | 0% | FALSE |
| T99-2187 | medulloblastoma | medulloblastoma | 43% | TRUE |
| T03-3674 | medulloblastoma | medulloblastoma | 71% | TRUE |
| T03-5070 | medulloblastoma | medulloblastoma | 100% | TRUE |
| T05-432 | medulloblastoma | medulloblastoma | 71% | TRUE |
| T05-7815 | medulloblastoma | inconclusive | 29% | FALSE |
| T02-8838 | PNET | PNET | 100% | TRUE |
| T97-15248 | PNET | PNET | 43% | TRUE |
| T02-16367 | PNET | astrocytoma | 0% | FALSE |

TABLE 3

| True type | samples | correct | incorrect | Inconclusive | Correct |
|---|---|---|---|---|---|
| astrocytoma | 8 | 7 | 1 | 0 | 88% |
| ependymoma | 9 | 7 | 2 | 0 | 78% |
| glioblastoma | 6 | 5 | 1 | 0 | 83% |
| Medulloblastoma | 9 | 7 | 1 | 1 | 78% |
| PNET | 3 | 2 | 1 | 0 | 67% |

TABLE 4

| Peptide | | Predictive |
|---|---|---|
| ID | Peptide name | strength |
| 93 | NTRK2_695_707_Y702/Y706/Y707 | 0.733 |
| 76 | LAT_249_261_Y255 | 0.511 |
| 102 | PDPK1_369_381_Y373/Y376 | 0.488 |
| 140 | VEGFR1_1040_1052_Y1048 | 0.482 |
| 6 | ANXA1_13_25_Y20/T23 | 0.482 |
| 19 | CREB1_122_134_Y134/S133 | 0.452 |
| 75 | LAT_194_206_Y200 | 0.446 |
| 116 | PTN11_535_547_Y542 | 0.443 |
| 98 | P85A_600_612_Y607/S608 | 0.431 |
| 135 | SYN1_2_14_S9/S11/Y3 | 0.428 |
| 49 | ERBB2_1241_1253_Y1248 | 0.415 |
| 64 | FRK_380_392_Y387 | 0.411 |
| 121 | RET_1022_1034_Y1029 | 0.406 |
| 53 | ERBB4_1277_1289_Y1284 | 0.398 |
| 91 | NTRK1_489_501_Y496 | 0.393 |
| 37 | ENOG_37_49_Y43 | 0.392 |
| 100 | PAXI_24_36_Y31 | 0.391 |
| 44 | EPHB1_771_783_Y778 | 0.374 |
| 111 | PLCG1_764_776_Y771 | 0.373 |
| 130 | STAT2_683_695_Y690 | 0.373 |
| 78 | LTK_669_681_Y772/Y776/Y777 | 0.371 |
| 25 | DDR2_733_745_Y740 | 0.359 |
| 38 | EPHA1_774_786_Y781 | 0.354 |
| 127 | SRC8_CHICK_492_504_Y499 | 0.346 |
| 117 | RAF1_331_343_S337/S338/Y339/Y340 | 0.343 |
| 67 | INSR_1348_1360_S1354/Y1355 | 0.339 |
| 148 | VEGFR2_1046_1058_Y1054 | 0.326 |
| 28 | EFS_246_258_Y253 | 0.326 |
| 86 | MK10_216_228_T221/Y223 | 0.321 |
| 72 | K2C6E_53_65_S59/Y61 | 0.308 |
| 109 | PGFRB_771_783_Y771/Y775/Y778 | 0.307 |
| 2 | pept41_653_665_Y627 | 0.297 |
| 101 | PDPK1_2_14_Y9 | 0.29 |
| 80 | MBP_259_271_Y261/Y268/S266 | 0.277 |
| 17 | CDK2_8_20_T14/Y15 | 0.269 |
| 22 | DCX_109_121_Y112/S116 | 0.266 |
| 106 | PGFRB_572_584_Y579/Y581 | 0.26 |
| 110 | PLCG1_1246_1258_S1248/Y1253 | 0.259 |
| 83 | MK01_180_192_Y187 | 0.247 |
| 99 | PAXI_111_123_Y118 | 0.243 |
| 27 | DYR1A_312_324_Y319/Y321 | 0.224 |
| 118 | RASA1_453_465_Y460 | 0.212 |
| 1 | pept41_348_660_Y354 | 0.209 |
| 108 | PGFRB_768_780_Y771/Y775/Y778 | 0.203 |
| 103 | PECA1_706_718_Y713 | 0.19 |
| 63 | FGFR3_753_765_Y760 | 0.178 |

### Example 3

In the method as described in example 1 the kinase activity of the tumor tissue samples were also compared to control tissue samples derived from cerebellum, myelum, temporal lobe and frontal and enthorhinal cortex processed according to the description in example 1.

The experiments showed a good reproducibility having a standard error of mean value smaller than 10% which is remarkably low compared to the reproducibility of microarray techniques.

### Example 4

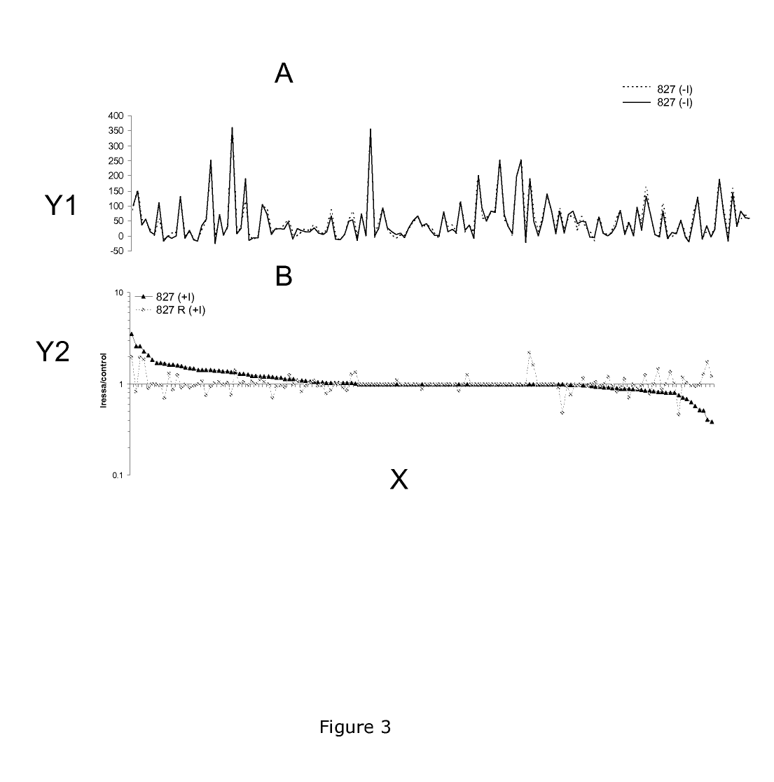

In order to assess the effect of the presence of a kinase inhibitor during the determination of the kinase activity, the kinase activity profile of samples of the tumor cell line HCC827 and the Gefitinib resistant HCC827GR6 celline are monitored in the presence and in the absence of a kinase inhibitor Gefitinib. Gefitinib is a selective inhibitor of epidermal growth factor receptor's (EGFR) tyrosine kinase domain. FIG. 3 shows the kinase activity profiles obtained in the absence (A) and in the presence (B) of Gefitinib. In the absence (A) of Gefitinib the kinase profiles of the HCC827 (dotted line) and HCC827GR6 (full line) tumor cell lines are apparently identical while the presence of Gefitinib (B) during the measurement of the kinase activity profile the ratio of the kinase activity over the control value shows a clear difference between the HCC827 (dotted line) and HCC827GR6 (full line) tumor cell lines.

This clearly shows that the presence of a kinase inhibitor results in a more explicit difference between the kinase activity profiles of the different tissues.

### Example 5

The method as described in example 1 was used to compare the kinase activity of normal colon tissue versus colon carcinoma tissue. Peptides showing an increase or decrease in phosphorylation between normal colon samples and colon carcinoma samples of more than 50%, with a significance of p<0.005, as determined with a one sample T-test, were identified. An increase in activity was seen for peptides 8, 16, 17, 28, 37, 38, 40, 43, 44, 50, 57, 59, 61, 64, 76, 77, 101, 103, 148, 153 and 156. An activity decrease was seen in peptides 5 and 78.

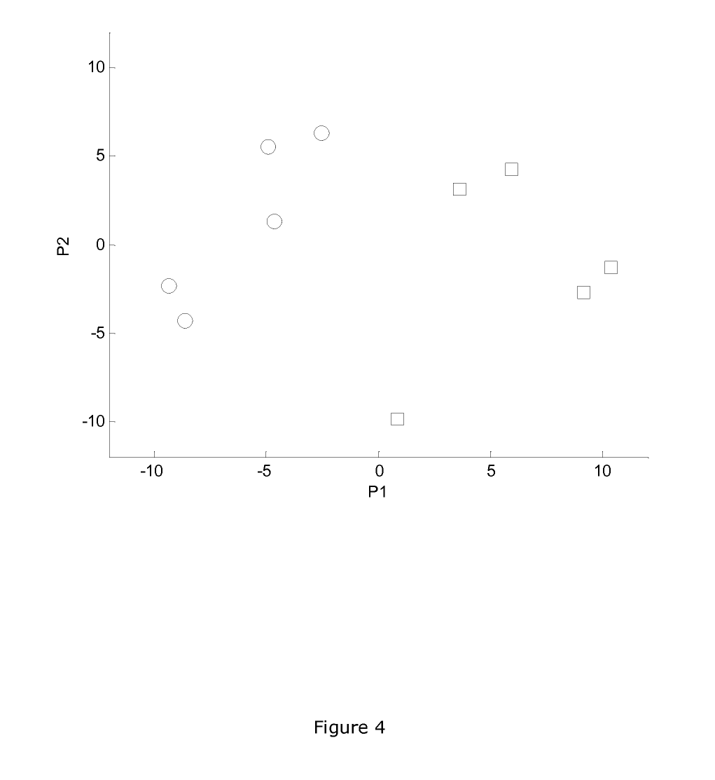

In addition, principal component analysis (PCA) was performed on the data as a dimension reduction technique (analysis performed in Matlab, The Mathworks Inc). Hereto the data was normalized per array by calculating z-scores, subsequently the data was normalized per peptide by calculating z-scores. Principal components where computed from the normalized data (including all substrates on the array). FIG. 4 shows the projection of the data on the first two principal components (axis labels P1 and P2, respectively) thus calculated. Each point represents a sample. Circle symbols represent data from normal colon samples, square symbols represent data from colon carcinoma samples. It can be clearly seen that the square symbols are separated from the circle symbols along the horizontal axis (representing the first principal component) thereby enabling the differentiation between normal colon samples and colon carcinoma samples.

### Example 6

The method as described in example 1 was used to compare the kinase activity of normal kidney versus a kidney tumor (Wilms tumor). Peptides showing an increase or decrease in phosphorylation between normal kidney samples and Wilms tumor samples of more than 50%, with a significance of p<0.005, as determined with a one sample T-test, were identified. A decrease in activity was seen for peptides 17, 28, 40, 43, 44, 93, 100, 103, 121 and 126.

### Example 7

The present example describes how the method of the present invention is used to determine a diagnostic set of peptide markers as provided in Table 5.

The kinase activity in lysates prepared from fresh frozen breast cancer tumors was determined in 23 frozen breast cancer tumors of which the Estrogen Receptor (ER) status was determined using a conventional method known in the art. 12 patients had a positive ER status, 11 patients a negative ER status. Each breast cancer tumor sample was measured 3 times.

6 coupes of 10 μm thickness of Tumor tissue were lysed in 100 microliter Mammalian Protein Extration Buffer (M-PER) containing phosphatase and protease inhibitors. After 30 minutes of lysis on ice, and centrifugation for 15 min at 4° C., the supernatants were aliquotted and frozen. 10 microgram protein contained in the lysis solution was pipetted into a reaction mixture composed of 1×ABL buffer (10×Abl buffer (New England Biolabs, cat.nr B6050S—100 mM MgCl2, 10 mM EGTA, 20 mM DTT and 0.1% Brij 35 in 500 mM Tris/HCI, pH 7.5), 0.1% Bovine Serum Albumin, 100 μM ATP, 12.5 μg/ml phosphotyrosine antibody to an end volume of 40 microliter The substrate arrays were blocked with 2% BSA just before the start of the incubation, followed by 3× washing of the arrays with 1×Abl buffer. After loading of the lysate reaction mixtures into substrate arrays comprising 256 protein kinase substrates, including the 77 protein kinase peptide substrates as listed in Table 5, incubation was commenced thereby measuring the kinase activity of the sample. During 60 cycles of pumping the lysate reaction mixture through the array, peptide phosphorylation was detected by an antibody present in the lysate reaction mixture. Real time data were obtained by measuring fluorescence of the bound anti-phosphotyrosine antibody after each 5 cycles. Images of the array were taken during the incubation of the array and after 60 cycles of incubation After 60 cycles of incubation and imaging, the antibody mixture was removed and the array was washed. Images were collected at different exposure times.

Signals for each spot on the image were quantified. Image quantification and data processing was conducted with dedicated PamGene software (Evolve and Bionavigator).

Subsequent data analysis was performed using Matlab (release 2007B, MathWorks Inc) wherein the phosphorylation signals were normalized, the average of the signal per spot was calculated and unsupervised analysis was performed by applying principal component analysis (PCA) to the obtained data.

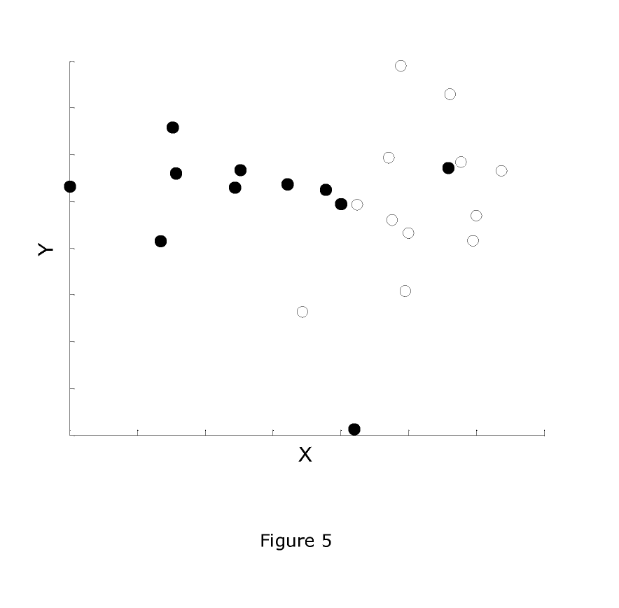

FIG. 5 shows the scores on the 4th principal component (PC) on the X-axis and that of the fifth PC on the Y axis. Each point represents one of the 23 samples, filled circles represent ER negative samples and open circles represent ER positive samples. It can be seen that ER positive samples tend to cluster with the ER positive samples and ER negative with the ER negative samples. This is a strong indication that ER positive and ER negative samples can indeed be discriminated between.

A classifier for ER-positive and ER-negative samples based on all the 256 spots in measurements could be constructed by applying Partial Least Squares Discriminant

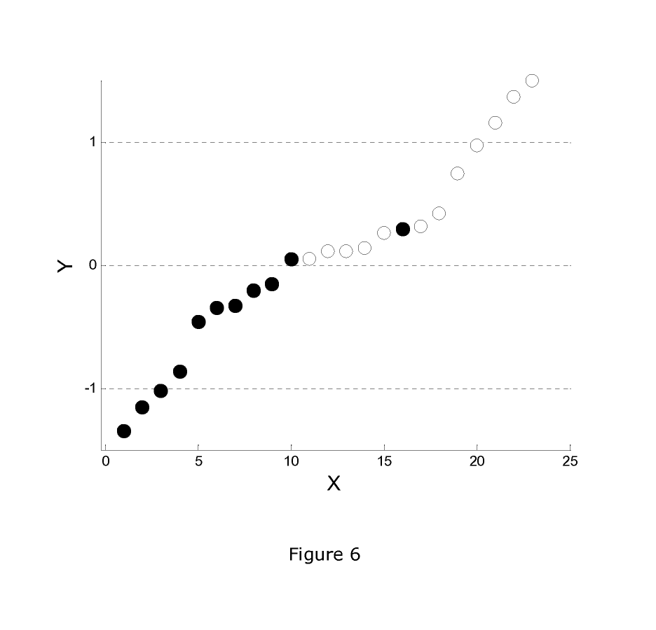

Analysis (PLS-DA). The performance of the classifier in predicting the class of an unseen sample was evaluated by applying Leave One Out Cross Validation: the classification of each individual breast tumor sample (the “test sample”) was predicted by a classifier based on all other samples (the “training samples”). The test sample was not involved in any way in constructing or optimizing the classifier, for each iteration of the cross validation the optimal number of PLS components was determined based on the training samples only. This procedure resulted in an unbiased estimate of the prediction error of the classifier. In total 75 protein kinase substrates were used in the PLS classifier (the sequences listed in Table 5 with the exception of Seq Id. Nos. 109 and 147) and enable the prediction of the ER status of each of the samples as shown in FIG. 6. In a separate embodiment of the invention the PLS classifier contains the protein kinase substrates with Seq Id. Nos. 111, 107, 101, 23, 38, 64, 71, 150, 158, 100, 72, 82, 159, 50, 182, 7, 183, 6, 61, 2, 121, 49, 43, 98, 102 and 28.

For each of the protein kinase substrates a univariate Anova was performed using the Matlab Statistics Toolbox 7.1. This protein kinase substrate profile is based on the protein kinase substrates with Seq Id. Nos. 109, 147, 111, 107, 101, 23, 38, 64, 71, 150, 158, 100, 72, 82, 159, 160, 161, 162, 163, 164, 165, 166, 167, 168, 169, 170, 171, 172, 173, 174, 175, 176, 177, 178, 179, 180 and/or 181 which have a p-value of <0.05 in the Anova. In a separate embodiment of the invention the Anova selected contain the protein kinase substrates with Seq Id. Nos. 109, 147, 111, 107, 101, 23, 38, 64, 71, 150, 158, 100, 72, 82 and/or 159.

FIG. 6 shows on the Y-axis the prediction obtained for each sample. The samples are sorted along the X-axis. ER negative samples are represented by a filled symbol, ER positive samples by an open symbol. Samples are classified as ER negative if the prediction<0 and as ER positive if the prediction>0. It can be seen that 2 ER negative samples are erroneously classified as ER positive samples: the classification error is 8.7%.

Consequently, the present example shows that the method of the present invention provides a set of peptide markers that enable the prediction of the ER status of a breast cancer, and moreover enables the classification of breast cancer according to the ER status.

TABLE 5
list of 77 peptides used for determining the
kinase activity, their sequence and Seq.Id.No.

| Seq. | Peptide | Peptide |
|---|---|---|
| Id.No | marker Name | marker Sequence |
| 109 | PGFRB_771_783 | YMAPYDNYVPSAP |
| 147 | VGFR1_1326_1338 | DYNSVVLYSTPPI |
| 111 | PLCG1_764_776 | IGTAEPDYGALYE |
| 107 | PGFRB_709_721 | RPPSAELYSNALP |
| 101 | PDPK1_2_14 | ARTTSQLYDAVPI |
| 23 | DDR1_506_518 | LLLSNPAYRLLLA |
| 38 | EPHA1_774_786 | LDDFDGTYETQGG |
| 64 | FRK_380_392 | KVDNEDIYESRHE |
| 71 | JAK1_1015_1027 | AIETDKEYYTVKD |
| 150 | VGFR2_1168_1180 | AQQDGKDYIVLPI |
| 158 | ADRB2_338_350 | ELLCLRRSSLKAY |
| 100 | PAXI_24_36 | FLSEETPYSYPTG |
| 72 | K2C6B_53_65 | GAGFGSRSLYGLG |
| 82 | MET_1227_1239 | RDMYDKEYYSVHN |
| 159 | NEK2_1_15 | MPSRAEDYEVLYTIG |
| 160 | BCAR_1365_379 | PPPAPDLYDVPPGLR |
| 161 | ANR26_289_303 | RKNLEATYGTVRTGN |
| 162 | HS90B_294_308 | DDITQEEYGEFYKSL |
| 163 | ADAM9_805_819 | PARPAPAPPLYSSLT |
| 164 | A4D108_43_57 | GDVSQFPYVEFTGRD |
| 165 | LDHB_233_247 | KMVVESAYEVIKLKG |
| 166 | EPHB3_607_621 | VYIDPFTYEDPNEAV |
| 167 | Q5VXI6_124_138 | ALEEDVIYDDVPCES |
| 168 | SG269_1100_1114 | PNPCSATYSNLGQSR |
| 169 | ABLM1_350_364 | RTSSESIYSRPGSSI |
| 170 | EFNB1_310_324 | ENNYCPHYEKVSGDY |
| 171 | LPHN2_1399_1413 | RSENEDIYYKSMPNL |
| 172 | STAM2_364_378 | LVNEAPVYSVYSKLH |
| 173 | TENS3_347_361 | GPVDGSLYAKVRKKS |
| 174 | KIRR1_714_728 | SGLERTPYEAYDPIG |
| 175 | LMO7_341_355 | RSWASPVYTEADGTF |
| 176 | ZO2_1111_1125 | AQKHPDIYAVPIKTH |
| 177 | MEMO1_203_217 | DESQGEIYRSIEHLD |
| 178 | ABLM1_454_468 | GSINSPVYSRHSYTP |
| 179 | LYN_498_512 | DDFYTATEGQYQQQP |
| 180 | EPHB2_773_787 | DDTSDPTYTSALGGK |
| 181 | DDX3X_259_273 | RYGRRKQYPISLVLA |
| 50 | ERBB2_870_882 | LDIDETEYHADGG |
| 182 | MK10_214_226 | AGTSFMMTPYVVT |
| 7 | ANXA2_17_ 29 | HSTPPSAYGSVKA |
| 183 | SYVC_871_885 | IDPLDVIYGISLQGL |
| 6 | ANXA1_14_26 | IENEEQEYVQTVK |
| 61 | FGFR2_762_774 | TLTTNEEYLDLSQ |
| 2 | 41_653_665 | RLDGENIYIRHSN |
| 121 | RET_1022_1034 | TPSDSLIYDDGLS |
| 49 | ERBB2_1241_1253 | PTAENPEYLGLDV |
| 43 | EPHA7_607_619 | TYIDPETYEDPNR |
| 98 | P85A_600_612 | NENTEDQYSLVED |
| 102 | PDPK1_369_381 | DEDCYGNYDNLLS |
| 28 | EFS_246_258 | GGTDEGIYDVPLL |
| 184 | ELMO2_706_720 | IPKEPSSYDFVYHYG |
| 185 | Q86W07_1330_1344 | QVFYNSEYGELSEPS |
| 186 | P85B_598_612 | KNETEDQYALMEDED |
| 187 | FGD6_747_761 | EYENIRHYEEIPEYE |
| 188 | SNX3_15_29 | PQNLNDAYGPPSNFL |
| 189 | SNAG_298_312 | TAADEEEDEYSGGLC |
| 190 | IRS2_816_830 | CGGDSDQYVLMSSPV |
| 191 | ITSN2_960_974 | REEPEALYAAVNKKP |
| 192 | ADDB_482_496 | PNQFVPLYTDPQEVL |
| 193 | UB7I3_323_337 | CPFIDNTYSCSGKLL |
| 194 | CK059_33_47 | LNGAEPNYHSLPSAR |
| 195 | MAP1B_1882_1896 | PDEEDYDYESYEKTT |
| 196 | MALD2_7_21 | SRNRDRRYDEVPSDL |
| 197 | TRXR1_295_309 | NKGKEKIYSAERFLI |
| 198 | ACTG_159_173 | VTHTVPIYEGYALPH |
| 199 | SNIP_129_143 | IYRKEPLYAAFPGSH |
| 200 | CBL_667_681 | SSSANAIYSLAARPL |
| 201 | ZNRF3_401_415 | RHGEQSLYSPQTPAY |
| 202 | BCAR1_320_334 | PLLREETYDVPPAFA |
| 203 | INT7_928_942 | VKSLEDPYSQQIRLQ |
| 204 | FAK1_854_868 | PIGNQHIYQPVGKPD |
| 205 | DOK1_402_416 | YNPATDDYAVPPPRS |
| 206 | CALR3_68_82 | TTQNGRFYAISARFK |
| 207 | HNRPF_299_313 | KATENDIYNFFSPLN |
| 208 | PABP1_357_371 | IVATKPLYVALAQRK |
| 209 | TWF1_320_334 | ELTADFLYEEVHPKQ |
| 210 | SPAST_205_219 | SKSQTDVYNDSTNLA |

1. A method identifying classification markers for tumors, comprising the steps of:
a) determining kinase activity of one or more diseased tissue samples by incubating said diseased tissue sample with ATP on an array of two or more substrates, preferably protein kinase substrates, thereby generating a kinase activity profile;
b) determining kinase activity of one or more control tissue samples by incubating said control tissue sample with ATP on an array of two or more substrates, preferably protein kinase substrates, thereby generating a kinase activity profile; and,
c) comparing the kinase activity profiles obtained in steps a) and b) for identifying classification markers.

2. The method according to claim 1, wherein three or more different tissue samples are compared in steps a) and b).

3. The method according to claim 1, further comprising the presence of a protein kinase inhibitor in steps a) and b).

4. The method according to claim 1, wherein said array is a flow-through array.

5. The method according to claim 1, wherein said diseased tissue sample is a tumor tissue sample and wherein said control tissue sample is a non-diseased tissue sample and/or a tissue sample similar to but different from the diseased tissue sample.

6. The method according to claim 1, wherein said substrates are at least two protein kinase substrates selected from the group consisting of the protein kinase substrates with any of SEQ ID NO: 1 to 157.

7. The method according to claim 1, for stratification, classification and/or sub-classification of tumors.

8. The method according to claim 1, for diagnosis, prognosis, and/or treatment prediction of tumors.

9. The method according to claim 1, for assessing susceptibility to a drug of a biological species having a specific disease state or cellular condition.

10. The method according to claim 1, for assessing susceptibility to a potential kinase inhibitor of a biological species having a specific disease state or cellular condition.

11. The method according to claim 1, for assessing the pharmaceutical value of a drug.

12. The method according to claim 1, for assessing the clinical value of a drug.

13. The method according to claim 1, further comprising the presence of a drug in steps a) and/or b).

14. An array for carrying out the method of claim 1, said array comprising at least two peptides selected from the group consisting of the peptides with any of SEQ ID NO: 1 to 157.

15. An array for carrying out the method of claim 1, said array comprising at least two peptides selected from the group consisting of the peptides with any of SEQ ID NO: 5, 8, 16, 17, 28, 37, 38, 40, 43, 44, 50, 57, 59, 61, 64, 76, 77, 78, 101, 103, 148, 153 and 156.

16. The array according to claim 14 for stratification, classification and/or sub-classification of tumors.

17. The array according to claim 14 for diagnosis, prognosis, and/or treatment prediction of tumors.

18. The array according to claim 14 for assessing susceptibility to a drug of a biological species having a specific disease state or cellular condition.

19. The array according to claim 14 for assessing susceptibility to a potential kinase inhibitor of a biological species having a specific disease state or cellular condition.

20. The array according to claim 14 for assessing the pharmaceutical value of a drug or for assessing the clinical value of a drug.


SEQUENCE LISTING (210 sequences)

SEQ ID NO: 1 - protein, 13 aa, Artificial
  peptide kinase substrate
LDGENIYIRHSNL

SEQ ID NO: 2 - protein, 13 aa, Artificial
  peptide kinase substrate
RLDGENIYIRHSN

SEQ ID NO: 3 - protein, 13 aa, Artificial
  peptide kinase substrate
WGRGTDEYFIRKP

SEQ ID NO: 4 - protein, 13 aa, Artificial
  peptide kinase substrate
YISKAEEYFLLKS

SEQ ID NO: 5 - protein, 13 aa, Artificial
  peptide kinase substrate
EREGSKRYCIQTK

SEQ ID NO: 6 - protein, 13 aa, Artificial
  peptide kinase substrate
IENEEQEYVQTVK

SEQ ID NO: 7 - protein, 13 aa, Artificial
  peptide kinase substrate
HSTPPSAYGSVKA

SEQ ID NO: 8 - protein, 12 aa, Artificial
  peptide kinase substrate
EAIYAAPFAKKK

SEQ ID NO: 9 - protein, 13 aa, Artificial
  peptide kinase substrate
TEATATDYHTTSH

SEQ ID NO: 10 - protein, 13 aa, Artificial
  peptide kinase substrate
TEASGYISSLEYP

SEQ ID NO: 11 - protein, 13 aa, Artificial
  peptide kinase substrate
FDKDGNGYISAAE

SEQ ID NO: 12 - protein, 13 aa, Artificial
  peptide kinase substrate
KDGNGYISAAELR

SEQ ID NO: 13 - protein, 13 aa, Artificial
  peptide kinase substrate
EGEEDTEYMTPSS

SEQ ID NO: 14 - protein, 13 aa, Artificial
  peptide kinase substrate
KDKMAEAYSEIGM

SEQ ID NO: 15 - protein, 13 aa, Artificial
  peptide kinase substrate
STATKDTYDALHM

SEQ ID NO: 16 - protein, 13 aa, Artificial
  peptide kinase substrate
EYEDENLYEGLNL

SEQ ID NO: 17 - protein, 13 aa, Artificial
  peptide kinase substrate
EKIGEGTYGVVYK

SEQ ID NO: 18 - protein, 13 aa, Artificial
  peptide kinase substrate
GLAKSFGSPNRAY

SEQ ID NO: 19 - protein, 13 aa, Artificial
  peptide kinase substrate
QKRREILSRRPSY

SEQ ID NO: 20 - protein, 13 aa, Artificial
  peptide kinase substrate
GPPEPGPYAQPSV

SEQ ID NO: 21 - protein, 13 aa, Artificial
  peptide kinase substrate
VADIDGQYAMTRA

SEQ ID NO: 22 - protein, 13 aa, Artificial
  peptide kinase substrate
GIVYAVSSDRFRS

SEQ ID NO: 23 - protein, 13 aa, Artificial
  peptide kinase substrate
LLLSNPAYRLLLA

SEQ ID NO: 24 - protein, 13 aa, Artificial
  peptide kinase substrate
FGMSRNLYAGDYY

SEQ ID NO: 25 - protein, 13 aa, Artificial
  peptide kinase substrate
RNLYSGDYYRIQG

SEQ ID NO: 26 - protein, 13 aa, Artificial
  peptide kinase substrate
KHDTEMKYYIVHL

SEQ ID NO: 27 - protein, 13 aa, Artificial
  peptide kinase substrate
CQLGQRIYQYIQS

SEQ ID NO: 28 - protein, 13 aa, Artificial
  peptide kinase substrate
GGTDEGIYDVPLL

SEQ ID NO: 29 - protein, 13 aa, Artificial
  peptide kinase substrate
GGTDEGIFDVPLL

SEQ ID NO: 30 - protein, 13 aa, Artificial
  peptide kinase substrate
EDSFLQRYSSDPT

SEQ ID NO: 31 - protein, 13 aa, Artificial
  peptide kinase substrate
GSVQNPVYHNQPL

SEQ ID NO: 32 - protein, 13 aa, Artificial
  peptide kinase substrate
APSRDPHYQDPHS

SEQ ID NO: 33 - protein, 13 aa, Artificial
  peptide kinase substrate
ISLDNPDYQQDFF

SEQ ID NO: 34 - protein, 13 aa, Artificial
  peptide kinase substrate
STAENAEYLRVAP

SEQ ID NO: 35 - protein, 13 aa, Artificial
  peptide kinase substrate
LGAEEKEYHAEGG

SEQ ID NO: 36 - protein, 13 aa, Artificial
  peptide kinase substrate
MTFGSKPYDGIPA

SEQ ID NO: 37 - protein, 13 aa, Artificial
  peptide kinase substrate
SGASTGIYEALEL

SEQ ID NO: 38 - protein, 13 aa, Artificial
  peptide kinase substrate
LDDFDGTYETQGG

SEQ ID NO: 39 - protein, 13 aa, Artificial
  peptide kinase substrate
QLKPLKTYVDPHT

SEQ ID NO: 40 - protein, 13 aa, Artificial
  peptide kinase substrate
EDDPEATYTTSGG

SEQ ID NO: 41 - protein, 13 aa, Artificial
  peptide kinase substrate
LNQGVRTYVDPFT

SEQ ID NO: 42 - protein, 13 aa, Artificial
  peptide kinase substrate
QAIKMDRYKDNFT

SEQ ID NO: 43 - protein, 13 aa, Artificial
  peptide kinase substrate
TYIDPETYEDPNR

SEQ ID NO: 44 - protein, 13 aa, Artificial
  peptide kinase substrate
DDTSDPTYTSSLG

SEQ ID NO: 45 - protein, 13 aa, Artificial
  peptide kinase substrate
SAIKMVQYRDSFL

SEQ ID NO: 46 - protein, 13 aa, Artificial
  peptide kinase substrate
IGHGTKVYIDPFT

SEQ ID NO: 47 - protein, 13 aa, Artificial
  peptide kinase substrate
SEHAQDTYLVLDK

SEQ ID NO: 48 - protein, 13 aa, Artificial
  peptide kinase substrate
ASAASFEYTILDP

SEQ ID NO: 49 - protein, 13 aa, Artificial
  peptide kinase substrate
PTAENPEYLGLDV

SEQ ID NO: 50 - protein, 13 aa, Artificial
  peptide kinase substrate
LDIDETEYHADGG

SEQ ID NO: 51 - protein, 13 aa, Artificial
  peptide kinase substrate
PISTIDVYMIMVK

SEQ ID NO: 52 - protein, 13 aa, Artificial
  peptide kinase substrate
QALDNPEYHNASN

SEQ ID NO: 53 - protein, 13 aa, Artificial
  peptide kinase substrate
IVAENPEYLSEFS

SEQ ID NO: 54 - protein, 13 aa, Artificial
  peptide kinase substrate
RLQRRRGSSIPQF

SEQ ID NO: 55 - protein, 13 aa, Artificial
  peptide kinase substrate
DSKNFDDYMKSLG

SEQ ID NO: 56 - protein, 13 aa, Artificial
  peptide kinase substrate
RYMEDSTYYKASK

SEQ ID NO: 57 - protein, 13 aa, Artificial
  peptide kinase substrate
RYIEDEDYYKASV

SEQ ID NO: 58 - protein, 13 aa, Artificial
  peptide kinase substrate
RQEDGGVYSSSGL

SEQ ID NO: 59 - protein, 13 aa, Artificial
  peptide kinase substrate
REEADGVYAASGG

SEQ ID NO: 60 - protein, 13 aa, Artificial
  peptide kinase substrate
ALTSNQEYLDLSM

SEQ ID NO: 61 - protein, 13 aa, Artificial
  peptide kinase substrate
TLTTNEEYLDLSQ

SEQ ID NO: 62 - protein, 13 aa, Artificial
  peptide kinase substrate
DVHNLDYYKKTTN

SEQ ID NO: 63 - protein, 13 aa, Artificial
  peptide kinase substrate
TVTSTDEYLDLSA

SEQ ID NO: 64 - protein, 13 aa, Artificial
  peptide kinase substrate
KVDNEDIYESRHE

SEQ ID NO: 65 - protein, 13 aa, Artificial
  peptide kinase substrate
RGEPNVSYICSRY

SEQ ID NO: 66 - protein, 13 aa, Artificial
  peptide kinase substrate
DGKKRKRSRKESY

SEQ ID NO: 67 - protein, 13 aa, Artificial
  peptide kinase substrate
SLGFKRSYEEHIP

SEQ ID NO: 68 - protein, 13 aa, Artificial
  peptide kinase substrate
YASSNPEYLSASD

SEQ ID NO: 69 - protein, 13 aa, Artificial
  peptide kinase substrate
SSEDLSAYASISF

SEQ ID NO: 70 - protein, 13 aa, Artificial
  peptide kinase substrate
GGGGGEFYGYMTM

SEQ ID NO: 71 - protein, 13 aa, Artificial
  peptide kinase substrate
AIETDKEYYTVKD

SEQ ID NO: 72 - protein, 13 aa, Artificial
  peptide kinase substrate
GAGFGSRSLYGLG

SEQ ID NO: 73 - protein, 13 aa, Artificial
  peptide kinase substrate
SAYGGLTSPGLSY

SEQ ID NO: 74 - protein, 13 aa, Artificial
  peptide kinase substrate
ALRADENYYKAQT

SEQ ID NO: 75 - protein, 13 aa, Artificial
  peptide kinase substrate
MESIDDYVNVPES

SEQ ID NO: 76 - protein, 13 aa, Artificial
  peptide kinase substrate
EEGAPDYENLQEL

SEQ ID NO: 77 - protein, 13 aa, Artificial
  peptide kinase substrate
RLIEDNEYTAREG

SEQ ID NO: 78 - protein, 13 aa, Artificial
  peptide kinase substrate
RDIYRASYYRRGD

SEQ ID NO: 79 - protein, 13 aa, Artificial
  peptide kinase substrate
ARTAHYGSLPQKS

SEQ ID NO: 80 - protein, 13 aa, Artificial
  peptide kinase substrate
FGYGGRASDYKSA

SEQ ID NO: 81 - protein, 13 aa, Artificial
  peptide kinase substrate
GRASDYKSAHKGF

SEQ ID NO: 82 - protein, 13 aa, Artificial
  peptide kinase substrate
RDMYDKEYYSVHN

SEQ ID NO: 83 - protein, 13 aa, Artificial
  peptide kinase substrate
HTGFLTEYVATRW

SEQ ID NO: 84 - protein, 13 aa, Artificial
  peptide kinase substrate
IMLNSKGYTKSID

SEQ ID NO: 85 - protein, 13 aa, Artificial
  peptide kinase substrate
AEHQYFMTEYVAT

SEQ ID NO: 86 - protein, 13 aa, Artificial
  peptide kinase substrate
TSFMMTPYVVTRY

SEQ ID NO: 87 - protein, 13 aa, Artificial
  peptide kinase substrate
ADSEMTGYVVTRW

SEQ ID NO: 88 - protein, 13 aa, Artificial
  peptide kinase substrate
RHTDDEMTGYVAT

SEQ ID NO: 89 - protein, 13 aa, Artificial
  peptide kinase substrate
QRSRKRLSQDAYR

SEQ ID NO: 90 - protein, 13 aa, Artificial
  peptide kinase substrate
AKALGKRTAKYRW

SEQ ID NO: 91 - protein, 13 aa, Artificial
  peptide kinase substrate
HIIENPQYFSDAC

SEQ ID NO: 92 - protein, 13 aa, Artificial
  peptide kinase substrate
PVIENPQYFGITN

SEQ ID NO: 93 - protein, 13 aa, Artificial
  peptide kinase substrate
FGMSRDVYSTDYY

SEQ ID NO: 94 - protein, 13 aa, Artificial
  peptide kinase substrate
RDVYSTDYYRVGG

SEQ ID NO: 95 - protein, 13 aa, Artificial
  peptide kinase substrate
DDSSAYRSVDEVN

SEQ ID NO: 96 - protein, 13 aa, Artificial
  peptide kinase substrate
SMSDPGVSYRTRE

SEQ ID NO: 97 - protein, 13 aa, Artificial
  peptide kinase substrate
EPHVTRRTPDYFL

SEQ ID NO: 98 - protein, 13 aa, Artificial
  peptide kinase substrate
NENTEDQYSLVED

SEQ ID NO: 99 - protein, 13 aa, Artificial
  peptide kinase substrate
VGEEEHVYSFPNK

SEQ ID NO: 100 - protein, 13 aa, Artificial
  peptide kinase substrate
FLSEETPYSYPTG

SEQ ID NO: 101 - protein, 13 aa, Artificial
  peptide kinase substrate
ARTTSQLYDAVPI

SEQ ID NO: 102 - protein, 13 aa, Artificial
  peptide kinase substrate
DEDCYGNYDNLLS

SEQ ID NO: 103 - protein, 13 aa, Artificial
  peptide kinase substrate
KKDTETVYSEVRK

SEQ ID NO: 104 - protein, 13 aa, Artificial
  peptide kinase substrate
QRSELDKSSAHSY

SEQ ID NO: 105 - protein, 13 aa, Artificial
  peptide kinase substrate
LDTSSVLYTAVQP

SEQ ID NO: 106 - protein, 13 aa, Artificial
  peptide kinase substrate
VSSDGHEYIYVDP

SEQ ID NO: 107 - protein, 13 aa, Artificial
  peptide kinase substrate
RPPSAELYSNALP

SEQ ID NO: 108 - protein, 13 aa, Artificial
  peptide kinase substrate
SSNYMAPYDNYVP

SEQ ID NO: 109 - protein, 13 aa, Artificial
  peptide kinase substrate
YMAPYDNYVPSAP

SEQ ID NO: 110 - protein, 13 aa, Artificial
  peptide kinase substrate
EGSFESRYQQPFE

SEQ ID NO: 111 - protein, 13 aa, Artificial
  peptide kinase substrate
IGTAEPDYGALYE

SEQ ID NO: 112 - protein, 13 aa, Artificial
  peptide kinase substrate
EGRNPGFYVEANP

SEQ ID NO: 113 - protein, 13 aa, Artificial
  peptide kinase substrate
LRPDSEASQSPQY

SEQ ID NO: 114 - protein, 13 aa, Artificial
  peptide kinase substrate
EQRMKESSFYSLC

SEQ ID NO: 115 - protein, 13 aa, Artificial
  peptide kinase substrate
WTASSPYSTVPPY

SEQ ID NO: 116 - protein, 13 aa, Artificial
  peptide kinase substrate
SKRKGHEYTNIKY

SEQ ID NO: 117 - protein, 13 aa, Artificial
  peptide kinase substrate
RPRGQRDSSYYWE

SEQ ID NO: 118 - protein, 13 aa, Artificial
  peptide kinase substrate
TVDGKEIYNTIRR

SEQ ID NO: 119 - protein, 13 aa, Artificial
  peptide kinase substrate
IYISPLKSPYKIS

SEQ ID NO: 120 - protein, 13 aa, Artificial
  peptide kinase substrate
VPTVSKGTVEGNY

SEQ ID NO: 121 - protein, 13 aa, Artificial
  peptide kinase substrate
TPSDSLIYDDGLS

SEQ ID NO: 122 - protein, 13 aa, Artificial
  peptide kinase substrate
AQAFPVSYSSSGA

SEQ ID NO: 123 - protein, 13 aa, Artificial
  peptide kinase substrate
SALLGDHYVQLPA

SEQ ID NO: 124 - protein, 13 aa, Artificial
  peptide kinase substrate
YVQLPATYMNLGP

SEQ ID NO: 125 - protein, 13 aa, Artificial
  peptide kinase substrate
VSQREAEYEPETV

SEQ ID NO: 126 - protein, 13 aa, Artificial
  peptide kinase substrate
EYEPETVYEVAGA

SEQ ID NO: 127 - protein, 13 aa, Artificial
  peptide kinase substrate
YQAEENTYDEYEN

SEQ ID NO: 128 - protein, 13 aa, Artificial
  peptide kinase substrate
LAKAVDGYVKPQI

SEQ ID NO: 129 - protein, 13 aa, Artificial
  peptide kinase substrate
DGPKGTGYIKTEL

SEQ ID NO: 130 - protein, 13 aa, Artificial
  peptide kinase substrate
NLQERRKYLKHRL

SEQ ID NO: 131 - protein, 13 aa, Artificial
  peptide kinase substrate
DPGSAAPYLKTKF

SEQ ID NO: 132 - protein, 13 aa, Artificial
  peptide kinase substrate
TERGDKGYVPSVF

SEQ ID NO: 133 - protein, 13 aa, Artificial
  peptide kinase substrate
PSDLLPMSPSVYA

SEQ ID NO: 134 - protein, 13 aa, Artificial
  peptide kinase substrate
MGKDGRGYVPATI

SEQ ID NO: 135 - protein, 13 aa, Artificial
  peptide kinase substrate
NYLRRRLSDSNFM

SEQ ID NO: 136 - protein, 13 aa, Artificial
  peptide kinase substrate
SGYSSPGSPGTPG

SEQ ID NO: 137 - protein, 13 aa, Artificial
  peptide kinase substrate
RYFLDDQYTSSSG

SEQ ID NO: 138 - protein, 13 aa, Artificial
  peptide kinase substrate
SDTEEQEYEEEQP

SEQ ID NO: 139 - protein, 13 aa, Artificial
  peptide kinase substrate
KIYSGDYYRQGCA

SEQ ID NO: 140 - protein, 13 aa, Artificial
  peptide kinase substrate
DFGLARDIYKNPD

SEQ ID NO: 141 - protein, 13 aa, Artificial
  peptide kinase substrate
DIFKNPDYVRKGD

SEQ ID NO: 142 - protein, 13 aa, Artificial
  peptide kinase substrate
KNPDYVRKGDTRL

SEQ ID NO: 143 - protein, 13 aa, Artificial
  peptide kinase substrate
VQQDGKDYIPINA

SEQ ID NO: 144 - protein, 13 aa, Artificial
  peptide kinase substrate
GSSDDVRYVNAFK

SEQ ID NO: 145 - protein, 13 aa, Artificial
  peptide kinase substrate
ATSMFDDYQGDSS

SEQ ID NO: 146 - protein, 13 aa, Artificial
  peptide kinase substrate
SSSPPPDYNSVVL

SEQ ID NO: 147 - protein, 13 aa, Artificial
  peptide kinase substrate
DYNSVVLYSTPPI

SEQ ID NO: 148 - protein, 13 aa, Artificial
  peptide kinase substrate
DFGLARDIYKDPD

SEQ ID NO: 149 - protein, 13 aa, Artificial
  peptide kinase substrate
DIYKDPDYVRKGD

SEQ ID NO: 150 - protein, 13 aa, Artificial
  peptide kinase substrate
AQQDGKDYIVLPI

SEQ ID NO: 151 - protein, 13 aa, Artificial
  peptide kinase substrate
VSDPKFHYDNTAG

SEQ ID NO: 152 - protein, 13 aa, Artificial
  peptide kinase substrate
RFRQGKDYVGAIP

SEQ ID NO: 153 - protein, 13 aa, Artificial
  peptide kinase substrate
EEAPEDLYKDFLT

SEQ ID NO: 154 - protein, 13 aa, Artificial
  peptide kinase substrate
DIYKDPDYVRKGS

SEQ ID NO: 155 - protein, 13 aa, Artificial
  peptide kinase substrate
KSFLDSGYRILGA

SEQ ID NO: 156 - protein, 13 aa, Artificial
  peptide kinase substrate
ALGADDSYYTARS

SEQ ID NO: 157 - protein, 13 aa, Artificial
  peptide kinase substrate
LRTHNGASPYQCT

SEQ ID NO: 158 - protein, 13 aa, Artificial Sequence
  Peptide ADRB2_338_350
ELLCLRRSSLKAY

SEQ ID NO: 159 - protein, 15 aa, Artificial Sequence
  Peptide NEK2_1_15
MPSRAEDYEVLYTIG

SEQ ID NO: 160 - protein, 15 aa, Artificial Sequence
  Peptide BCAR1_365_379
PPPAPDLYDVPPGLR

SEQ ID NO: 161 - protein, 15 aa, Artificial Sequence
  Peptide ANR26_289_303
RKNLEATYGTVRTGN

SEQ ID NO: 162 - protein, 15 aa, Artificial Sequence
  Peptide HS90B_294_308
DDITQEEYGEFYKSL

SEQ ID NO: 163 - protein, 15 aa, Artificial Sequence
  Peptide ADAM9_805_819
PARPAPAPPLYSSLT

SEQ ID NO: 164 - protein, 15 aa, Artificial Sequence
  Peptide A4D108_43_57
GDVSQFPYVEFTGRD

SEQ ID NO: 165 - protein, 15 aa, Artificial Sequence
  Peptide LDHB_223_247
KMVVESAYEVIKLKG

SEQ ID NO: 166 - protein, 15 aa, Artificial Sequence
  Peptide EPHB3_607_621
VYIDPFTYEDPNEAV

SEQ ID NO: 167 - protein, 15 aa, Artificial Sequence
  Peptide Q5VX16_124_138
ALEEDVIYDDVPCES

SEQ ID NO: 168 - protein, 15 aa, Artificial Sequence
  Peptide SG269_1100_1114
PNPCSATYSNLGQSR

SEQ ID NO: 169 - protein, 15 aa, Artificial Sequence
  Peptide ABLM1_350_364
RTSSESIYSRPGSSI

SEQ ID NO: 170 - protein, 15 aa, Artificial Sequence
  Peptide EFNB1_310_324
ENNYCPHYEKVSGDY

SEQ ID NO: 171 - protein, 15 aa, Artificial Sequence
  Peptide LPHN2_1399_1413
RSENEDIYYKSMPNL

SEQ ID NO: 172 - protein, 15 aa, Artificial Sequence
  Peptide STAM2_364_378
LVNEAPVYSVYSKLH

SEQ ID NO: 173 - protein, 15 aa, Artificial Sequence
  Peptide TENS3_347_361
GPVDGSLYAKVRKKS

SEQ ID NO: 174 - protein, 15 aa, Artificial Sequence
  Peptide KIRR1_714_728
SGLERTPYEAYDPIG

SEQ ID NO: 175 - protein, 15 aa, Artificial Sequence
  Peptide LMO7_341_355
RSWASPVYTEADGTF

SEQ ID NO: 176 - protein, 15 aa, Artificial Sequence
  Peptide ZO2_1111_1125
AQKHPDIYAVPIKTH

SEQ ID NO: 177 - protein, 15 aa, Artificial Sequence
  Peptide MEMO1_203_217
DESQGEIYRSIEHLD

SEQ ID NO: 178 - protein, 15 aa, Artificial Sequence
  Peptide ABLM1_454_468
GSINSPVYSRHSYTP

SEQ ID NO: 179 - protein, 15 aa, Artificial Sequence
  Peptide LYN_498_512
DDFYTATEGQYQQQP

SEQ ID NO: 180 - protein, 15 aa, Artificial Sequence
  Peptide EPHB2_773_787
DDTSDPTYTSALGGK

SEQ ID NO: 181 - protein, 15 aa, Artificial Sequence
  Peptide DDX3X_259_273
RYGRRKQYPISLVLA

SEQ ID NO: 182 - protein, 13 aa, Artificial Sequence
  Peptide MK10_214_226
AGTSFMMTPYVVT

SEQ ID NO: 183 - protein, 15 aa, Artificial Sequence
  Peptide SYVC_871_885
IDPLDVIYGISLQGL

SEQ ID NO: 184 - protein, 15 aa, Artificial Sequence
  Peptide ELMO2_706_720
IPKEPSSYDFVYHYG

SEQ ID NO: 185 - protein, 15 aa, Artificial Sequence
  Peptide Q86W07_1330_1344
QVFYNSEYGELSEPS

SEQ ID NO: 186 - protein, 15 aa, Artificial Sequence
  Peptide P85B_598_612
KNETEDQYALMEDED

SEQ ID NO: 187 - protein, 15 aa, Artificial Sequence
  Peptide FGD6_747_761
EYENIRHYEEIPEYE

SEQ ID NO: 188 - protein, 15 aa, Artificial Sequence
  Peptide SNX3_15_29
PQNLNDAYGPPSNFL

SEQ ID NO: 189 - protein, 15 aa, Artificial Sequence
  Peptide SNAG_298_312
TAADEEEDEYSGGLC

SEQ ID NO: 190 - protein, 15 aa, Artificial Sequence
  Peptide IRS2_816_830
CGGDSDQYVLMSSPV

SEQ ID NO: 191 - protein, 15 aa, Artificial Sequence
  Peptide ITSN2_960_974
REEPEALYAAVNKKP

SEQ ID NO: 192 - protein, 15 aa, Artificial Sequence
  Peptide ADDB_482_496
PNQFVPLYTDPQEVL

SEQ ID NO: 193 - protein, 15 aa, Artificial Sequence
  Peptide UB713_323_337
CPFIDNTYSCSGKLL

SEQ ID NO: 194 - protein, 15 aa, Artificial Sequence
  Peptide CK059_33_47
LNGAEPNYHSLPSAR

SEQ ID NO: 195 - protein, 15 aa, Artificial Sequence
  Peptide MAP1B_1882_1896
PDEEDYDYESYEKTT

SEQ ID NO: 196 - protein, 15 aa, Artificial Sequence
  Peptide MALD2_7_21
SRNRDRRYDEVPSDL

SEQ ID NO: 197 - protein, 15 aa, Artificial Sequence
  Peptide TRXR1_295_309
NKGKEKIYSAERFLI

SEQ ID NO: 198 - protein, 15 aa, Artificial Sequence
  Peptide ACTG_159_173
VTHTVPIYEGYALPH

SEQ ID NO: 199 - protein, 15 aa, Artificial Sequence
  Peptide SNIP_129_143
IYRKEPLYAAFPGSH

SEQ ID NO: 200 - protein, 15 aa, Artificial Sequence
  Peptide CBL_667_681
SSSANAIYSLAARPL

SEQ ID NO: 201 - protein, 15 aa, Artificial Sequence
  Peptide ZNRF3_401_415
RHGEQSLYSPQTPAY

SEQ ID NO: 202 - protein, 15 aa, Artificial Sequence
  Peptide BCAR1_320_334
PLLREETYDVPPAFA

SEQ ID NO: 203 - protein, 15 aa, Artificial Sequence
  Peptide INT7_928_942
VKSLEDPYSQQIRLQ

SEQ ID NO: 204 - protein, 15 aa, Artificial Sequence
  Peptide FAK1_854_868
PIGNQHIYQPVGKPD

SEQ ID NO: 205 - protein, 15 aa, Artificial Sequence
  Peptide DOK1_402_416
YNPATDDYAVPPPRS

SEQ ID NO: 206 - protein, 15 aa, Artificial Sequence
  Peptide CALR_68_82
TTQNGRFYAISARFK

SEQ ID NO: 207 - protein, 15 aa, Artificial Sequence
  Peptide HNRPF_299_313
KATENDIYNFFSPLN

SEQ ID NO: 208 - protein, 15 aa, Artificial Sequence
  Peptide PABP1_357_371
IVATKPLYVALAQRK

SEQ ID NO: 209 - protein, 15 aa, Artificial Sequence
  Peptide TWF1_320_334
ELTADFLYEEVHPKQ

SEQ ID NO: 210 - protein, 15 aa, Artificial Sequence
  Peptide SPAST_205_219
SKSQTDVYNDSTNLA